(19) United States
(12) Patent Application Publication
(10) Pub. No.: US 2015/0379591 A1
(43) Pub. Date: Dec. 31, 2015

(54) Method, System, And Software For Generating Performance Metrics Of Charity Effectiveness

(71) Applicant: Michael Massarik, Los Angeles, CA (US)

(72) Inventor: Michael Massarik, Los Angeles, CA (US)

(21) Appl. No.: 14/849,214

(22) Filed: Sep. 9, 2015

Related U.S. Application Data
(63) Continuation-in-part of application No. 13/492,755, filed on Jun. 8, 2012.
(60) Provisional application No. 61/494,986, filed on Jun. 9, 2011.

(51) Int. Cl. G06Q 30/02; G06Q 40/00; G06Q 10/06

(52) U.S. Cl. CPC G06Q 30/0279; G06Q 10/06393; G06Q 40/10

(57) ABSTRACT

A method, system and software for generating objective metrics reflecting a charity's fiscal behavior and financial effectiveness. The system includes a metrics server receiving a search request for a charity and in turn, retrieving profile information on the charity from a first database and financial information on the charity from a second database. At least one metrics generator analyzes the financial information to generate one or more objective scores useful for comparing charities to each other. The scores indicate, for example, how effective the charity is and charities can be assigned unique identification codes.

### FIELD OF THE INVENTION

This invention relates to e-philanthropy, specifically to online marketplaces, exchanges, and transactions in a social networking environment. In particular it describes creation of a central clearinghouse or exchange where charities can register and market themselves to potential patrons or donors, who can search, find and contribute to charities and nonprofit organizations within an online social network. This application is a continuation-in-part of application Ser. No. 13/492,755, the contents of which are incorporated by reference herein.

### BACKGROUND OF THE INVENTION

The main challenge for charitable organizations and causes is fund-raising. It is expensive and requires substantial marketing effort. A potential patron to a charitable cause or organization also faces several challenges: finding suitable beneficiaries; verifying the legitimacy of them; and transmitting funds to selected beneficiaries.

Currently there exists no centralized exchange which effectively connects charities with potential patrons, which provides standardized, objective information about the caliber and authenticity of the charities, which allows charities to compete for contributions, and which provides patrons with a simple way to construct and contribute to portfolios of charities. This problem of connecting supply and demand is a familiar one dating back to the beginnings of human trade and commerce. A relevant example is the development of securities trading as it evolved from unregulated small transactions to centralized trading on competitive open stock exchanges that only list companies which meet certain standards and publicly disclose their records. A similar evolution has occurred in many industries, and much of the rapid expansion of the internet has been driven by the creation of virtual marketplaces which connect both sides of a potential trade. The problem is consistently, safely and effectively connecting two sides of a potential deal, providing necessary information and disclosure, and providing a list of competitive products, whether it is about selling one's used goods on eBay, finding a potential mate on Match.com, or trading stocks on E*TRADE.

Today when a patron researches a charity on the internet (or by other means), the patron typically visits many different websites, collecting piecemeal information which may not provide answers sufficient to make informed contribution decisions. Further, the unique nature of the Internet often permits incomplete or incorrect information about a charity to be the information that is most readily accessible to potential donors. The Internet is largely unregulated and potential patrons have no reliable means for verifying information obtained regarding charities. It is therefore difficult for a potential donor in the modern era to ensure that his or her donation is directed in the most effective manner toward the cause to which it is intended. In other words, while the Internet has improved the speed by which a donation transaction can be completed, it has also created new challenges for potential donors that exacerbates the problem of information asymmetry between the pool of charities and the pool of potential donors.

What is needed is a technology which can bring patrons and charitable entities together in an orderly and effective way. Such a technology would help simplify and optimize transactions, organize charitable contributions, provide greater visibility, potentially increase charitable contributions, and bring needed turn-key solutions to charities who presently appear to underestimate the impact technology could have on their fund raising capabilities.

Accordingly, the present invention described herein addresses these obstacles by providing an e-philanthropy clearinghouse for charitable contributions. This exchange lists registered charities and serves as a supermarket for potential patrons who can use it to shop for charitable organizations or causes to support. It provides patrons with a searchable database of donation targets, standardized information about the targets, authentication of targets, and a mechanism for transferring funds to selected targets. It also helps patrons log their activity and keep track of their charitable contributions for tax and accounting purposes, and further provides charities and patrons with the opportunity to create social networks for establishing local or global support for specific causes and charitable organizations.

### SUMMARY OF THE INVENTION

It is an object of the present invention to provide a method, system, and means for creating a central exchange market place for charities and charitable contributions in an online social network environment. As used herein, the term “charity” encompasses a charity, charitable organization, non-profit organization, private foundation, church, and/or religious organization.

A fundamental feature of this invention is that charities will compete in a central market place for contributions. Charities with low expense ratios, which can be thought of as a metric which is the quotient of total contributions received by said charity divided by the total of all of said charity's expenses (the “FG Expense Number”, as defined hereinbelow), shows that the charity is working more effectively by a lower overhead and a greater giving to their cause or mission statement. A charity with lower expenses will be more competitive than a charity with higher expenses and which gives less to their cause or mission statement. Another important metric which shows the effectiveness of how a charity does business is the quotient of total contributions received by said charity divided by the total funds expended by said charity on goods and services directly related to the charity's cause/mission statement (the “Fastgiving Number”, as defined hereinbelow). The prior metric shows that a charity is more effective in dispersing funds for goods and services to their cause/mission statement than a charity which is keeping more of their contribution and dispersing less funds to their cause/mission statement. The invention thus provides a way to compare charities directly through standardized information so there is transparency and information symmetry. A potential patron can come to the online marketplace and easily discover standardized information, somewhat analogous to standard stock metrics, needed to make educated decisions. This information comprises its expense ratios, the amount it gives to its cause/mission statement ratio, how it allocates contributions, the name of its accounting firm, its priorities, mission statement, videos and information about the charity, how it gives, a personal message to its patrons, current news about the charity, its country of origin, legal status, and general verification that the information is correct with regard to public record or other verification processes.

The present invention provides such a technology by creating a central exchange market place for charities and potential patrons in an online social networking environment. In some respects it can be likened to a combination of an online securities trading engine such as E*TRADE—where the investments are charitable contributions in this case—and a social networking engine such as Facebook. This combination brings the ability to execute rapid online transactions with pre-qualified entities together with the dissemination power of online social networking. In short, embodiments of the present invention provide novel solutions to unique technological problems inherent in the Internet marketplace. Providing one or more objective metrics in a central exchange or social networking website directly addresses the problem of information asymmetry between charities and potential patrons that is exacerbated by the Internet.

The invention will benefit charities in a number of ways: provide visibility; let them compete for contributions in a competitive marketplace; make it easier to accept contributions through credit card, Pay-Pal, electronic check, texting, etc; enable rapid and wide communication with the charity's patron bases; reduce the cost of fundraising events; increase their potential patron base; and provide a fast way to receive contributions for urgent events such as natural disasters, etc. (With respect to urgent events such as natural disasters, for example, charities can distinguish themselves from others by improving their objective metrics, such as the FG Expense Number and/or Fastgiving Number, and thereby be more likely to participate in dealing with such urgent events). It will also benefit patrons by providing an easily accessible central location to search legitimate charities; easily distinguish between charities via unique identifiers; instant information about how contributions are spent by a charity; standardized performance metrics (e.g., financial ratios, expense ratios) of the charity, which show, among other things the ratio of contributions spent and how effective each charity is; easy ways to provide payment; participation in disaster relief; and quick access to consolidated contribution statements for tax purposes.

The invention also allows for sponsoring entities to set up a portfolio of charities with a designation of how each contribution gets divided between portfolio charities. Such a portfolio would thus act somewhat like a stock mutual fund, and a patron could thus contribute to a general cause like cancer and cover several charities rather than contributing to individual charities focused on cancer. In some embodiments, this may be referred to as “cause driven contributions” or “cause driven giving.” The sponsoring entity could participate with matching funds or co-contributions to the portfolio charities, and it along with, in some embodiments, the charities themselves, might also provide gifts of goods or services or coupons for goods and services to the patrons to incentivize giving.

It is another object of the present invention to provide a system, method, and means for generating objective performance metrics reflecting the fiscal behavior and financial effectiveness of a charity.

It is yet another object of the present invention to provide a system, method, and means for generating standardized performance metrics for multiple charities to measure and compare with one another the financial effectiveness of each charity.

It is a further object of the present invention to provide a system, method, and means for calculating objective performance metrics reflecting the fiscal behavior and financial effectiveness of a charity and displaying the performance metrics in an online network environment. For example, the performance metrics for a specific charity are presented within a particular website (e.g., exchange or clearinghouse-type website) where a user is researching the charity. In another example, the performance metrics for a specific charity are displayed in the search results—such as, at the top or right-hand side of the search results list—of a search engine (e.g., Google®, Bing®, Yahoo!®) once a search request for the specific charity is conducted. In some embodiments, the present invention is in the form of a dedicated software application, or “App,” that allows for the display of a single metric for a charity, multiple metrics for a charity, and/or the ability to compare a charity and their metric(s) to other charities and their metric(s).

According to one embodiment of the present invention, a system for generating metrics reflecting a charity's fiscal behavior and financial effectiveness is provided. The system comprises: at least one metrics server in communication with at least one terminal, the metrics server for receiving a search request from one of the at least one terminal, the search request being a signal requesting a search on a charity; the at least one metrics server for retrieving profile information on the charity from a first database over a network and for retrieving financial information on the charity from a second database over the network; at least one metrics generator for analyzing the financial information to obtain data on a total amount of contributions received by the charity in a given tax period and data on a total amount of contributions spent by the charity in advancing a cause of the charity in the given tax period, the at least one metrics generator using the data on the total contributions received amount and the total contributions spent amount to generate at least one first score which indicates how effective the charity is in dispersing funds for goods and/or services related to the cause of the charity; and a network interface controller transmitting the at least one first score to the one of the at least one terminal for display.

In some embodiments, the system further comprises that the first score indicating how effective the charity is in dispersing funds for goods and/or services related to the cause of the charity is determined as a ratio of the total contributions received amount to the total contributions spent amount. In some embodiments, the system further comprises that the total contributions spent amount is calculated from a sum of grants and/or endowments given to a domestic government, grants and/or endowments given to individuals, and grants and/or endowments given to foreign governments.

In some embodiments, the system further comprises that the at least one metrics generator comprises a first metrics generator and a second metrics generator; the first metrics generator generating the first score indicating how effective the charity is in dispersing funds for goods and/or services related to the cause of the charity; the second metrics generator for analyzing the financial information retrieved from the second database to obtain data on the total amount of contributions received by the charity in the given tax period and data on expenses of the charity in the given tax period, the second metrics generator using the data on the total contributions received amount and the expenses to generate a second score indicating how effectively the charity operates; the network interface controller transmitting the first score generated by the first metrics generator and the second score generated by the second metrics generator to the one of the at least one terminal for display.

In some embodiments, the system further comprises that the second score indicating how effectively the charity operates is determined as a ratio of the total contributions received amount to the expenses of the charity and that the expenses of the charity is calculated from gross total operating expenses of the charity in the given tax period minus a sum of grants and/or endowments given to a domestic government, grants and/or endowments given to individuals, and grants and/or endowments given to foreign governments.

In some embodiments, the system further comprises that the network interface controller establishes communication links to the first and second databases upon the at least one metrics server receiving the search request, and further monitors a status of the communications links. In some embodiments, the system further comprises that the at least one metrics server searches through the first database using an identification code associated with the charity to obtain the profile information on the charity, the identification code having been assigned to the charity by a tax agency; and the at least one metrics server using the identification code to search through the second database to retrieve the financial information which has a matching identification code.

In some embodiments, the system further comprises a memory storage unit for saving the at least one first score generated by the at least one metrics generator and for saving at least one of the profile information from the first database or the financial information from the second database. In some embodiments, the system further comprises that the at least one metrics server transmits the at least one first score for display within a website providing at least one of an online marketplace or social network environment for charities and patrons. In some embodiments, the system further comprises that the at least one metrics server transmits the at least one first score for display in a search result list created by a search engine in response to a search for the charity being initiated in the search engine. In some embodiments, the system further comprises that the system generates an identification code for identifying the charity and associates the identification code to the at least one first score.

According to a second embodiment of the present invention, a system for generating metrics reflecting a charity's fiscal behavior and financial effectiveness is provided. The system comprises: at least one metrics server in communication with at least one terminal, the metrics server for receiving a search request from one of the at least one terminal, the search request being a signal requesting a search on a first charity; a network interface controller configured to establish communication links between the at least one metrics server and a first database and a second database over a network in response to the search request; the at least one metrics server for retrieving profile information on the first charity from the first database and for retrieving financial information on the first charity from the second database; at least one metrics generator for analyzing the financial information retrieved from the second database to obtain data on a total amount of contributions received by the first charity in a given tax period and data on a total amount of contributions spent by the first charity in advancing a cause of the first charity in the given tax period, the at least one metrics generator using the data on the total contributions received amount and the total contributions spent amount to generate at least one first score which indicates how effective the first charity is in dispersing funds for goods and/or services related to the cause of the first charity; and a web host unit which hosts a website providing an online marketplace for charities and patrons, the website comprising a charity webpage for each of the charities, wherein the web host unit is configured to transmit the charity webpage for the first charity with the at least one objective score for display on the one of the at least one terminal in response to the search request.

In some embodiments, the system further comprises that the at least one metrics generator comprises a first metrics generator and a second metrics generator; the first metrics generator for generating the first score indicating how effective the first charity is in dispersing funds for goods and/or services related to the cause of the first charity; the second metrics generator for analyzing the financial information retrieved from the second database to obtain data on the total amount of contributions received by the first charity in the given tax period and data on expenses (excluding amounts paid in furtherance of the charity's cause) of the first charity in the given tax period, the second metrics generator using the data on the total contributions received amount and the expenses to generate a second score indicating how effective the first charity operates; the web host unit transmitting the charity webpage for the first charity with the first and second scores for display on the one of the at least one terminal. In some embodiments, the system further comprises that the system generates an identification code for identifying the first charity and associates the identification code to the at least one first score.

According to a third embodiment of the present invention, a method for generating metrics reflecting a charity's fiscal behavior and financial effectiveness is provided. The method comprises the steps of: initiating a network interface controller to establish communication connections between at least one metrics server and a first database and a second database; retrieving profile information on a charity from the first database and financial information on the charity from the second database; analyzing the financial information on the metrics server to obtain data on a total amount of contributions received by the charity in a given tax period and data on a total amount of contributions spent by the charity in advancing a cause of the charity in the given tax period; generating a first score using the data on the total contributions received amount and the total contributions spent amount, the first score indicating how effective the charity is in dispersing funds for goods and/or services related to the cause of the charity; and transmitting the first score from the metrics server to at least one terminal for display.

In some embodiments, the method further comprises that the first score indicating how effective the charity is in dispersing funds for goods and/or services related to the cause of the charity is determined as a ratio of the total contributions received amount to the total contributions spent amount, which is calculated from a sum of grants and/or endowments given to a domestic government, grants and/or endowments given to individuals, and grants and/or endowments given to foreign governments. In some embodiments, the method further comprises the steps of: analyzing the financial information on the metrics server to obtain data on the total amount of contributions received by the charity in the given tax period and data on expenses of the charity in the given tax period; generating a second score using the data on the total contributions received amount and expenses, the second objective score indicating how effective the charity operates; wherein the second score is determined as a ratio of the total contributions received amount to the expenses of the charity; and wherein the expenses of the charity is calculated from gross total operating expenses of the charity in the given tax period minus a sum of grants and/or endowments given to a domestic government, grants and/or endowments given to individuals, and grants and/or endowments given to foreign governments; and transmitting the second objective score from the metrics server to the at least one terminal for display.

In some embodiments, the method further comprises that the steps of retrieving the profile information and the financial information further comprises: searching through the first database using an identification code associated with the charity to obtain the profile information on the charity, the identification code having been assigned to the charity by a tax agency; and searching through the second database using the identification code to retrieve the financial information which has a matching identification code.

In some embodiments, the method further comprises the steps of saving, in a memory storage unit, the objective score indicating how effective the charity is in dispersing funds for goods and/or services related to the cause of the charity and of saving in the memory storage unit, the profile information from the first database and the financial information from the second database. In some embodiments, the method further comprises that the transmitting step includes transmitting the objective score for display within a website providing an online marketplace for charities and patrons. In some embodiments, the method further comprises that the transmitting step includes transmitting the objective score for display in a search result list created by a search engine in response to a search for the charity being initiated in the search engine.

The system according to yet another embodiment of the present teachings includes, but is not limited to, at least one performance metrics server in communication with one or more IRS databases and at least one user terminal. In one embodiment, two IRS databases (e.g., servers), which are managed by the Internal Revenue Service, contain profile, background and financial information for all charities organized and/or doing business within the United States. It is noted that tax filing documents (such as annual returns and exemption applications) filed with the IRS are available for public inspection. A first IRS database stores data on each charity concerning the organization's official name, employer identification number (EIN) assigned by the IRS, agent/contact name (e.g., in care of), and main address (street number, street name, city, state, zip code, country). A second IRS database associates the EINs with financial records data of the respective charities. In some embodiments, the information and data stored within the IRS databases may be organized in a comma separated values (csv) format, for example, an EIN Master CSV file for the first IRS database and a Finance CSV file for the second IRS database. In another embodiment, the information and data stored within the IRS databases may be organized in an extensible markup language (xml) format. In yet other embodiments, the information and data stored within the IRS databases may be arranged in spreadsheet (xls) format, generic text (txt) format, or other file formats.

The financial record data stored in the second IRS database includes various data entries that are filed by the charities in IRS forms 990, 990-EZ and/or 990-PF. For example, the data entries comprise, but are not limited to, the tax period, the total amount of contributions received by the charity in the given tax period (e.g., income from direct and indirect revenue sources received by the charity), the total amount of contributions used in spending by the charity in the given tax period (e.g., amount of direct and indirect revenue paid for goods and/or services directed to the charity's mission or cause)—including the amount of grants/endowments to the government, the amount of grants/endowments to individuals, and the amount of grants/endowments to foreign governments—, as well as the charity's total operating expenses for the given tax period. The financial records may also comprise, but are not limited to, data entries pertaining to investment income, royalties, gross rents—real estate, gross rents—personal property, rental expense—real estate, rental expense—personal property, net rent—real estate, net rent—personal property, net rental income, gross sales—securities, gross sales—other assets, sales expense—securities, sales expense—other assets, net gain from sales—securities, net gain from sales—other assets, sales of assets, gross fundraising, fundraising expenses, fundraising income, other revenue, total revenue, compensation of current officers, directors, trustees, and key employees, and other salaries and wages.

The performance metrics server is designed to obtain and retrieve the above sets of data/information from both the first and second IRS databases. In some embodiments, the performance metrics server may have a dedicated connection to the IRS databases. In other embodiments, the performance metrics server is connected to the IRS databases over a network, such as a local area network (LAN), wide area network (WAN), metropolitan area network (MAN), or the Internet. The performance metrics server comprises at least a network interface control unit for establishing the communication connections with the first and second IRS databases as well as the one or more user terminals over the network. The network interface control unit further monitors the status of the network connections, to confirm whether up-to-date data/information is being received from the IRS databases. A memory storage unit is also provided to periodically (e.g., hourly, daily, weekly, biweekly, monthly, quarterly, bi-annually, annually) save up-to-date data/information on the charities obtained from the IRS databases into local and/or temporary memory. The memory storage unit is especially useful in situations where the network interface control unit is unable to establish communication with the IRS database. Where communications between the performance metrics server and the IRS databases fail, the server is still able to analyze the financials of a charity using the data/information stored in the memory storage unit, provide financial analytics, and generate performance metrics regarding the fiscal behavior and financial effectiveness of the charity.

The performance metrics server further includes at least two metrics generators, each being configured to generate an objective performance metric. For example, one generator obtains specific financial data entries from the second IRS database (Finance CSV file) on a particular charity to calculate the ratio of the total contributions received by the charity to the total funds expended by the charity on goods and services directly related to the charity's cause/mission for a given tax period (“Fastgiving Number”). Another generator calculates the ratio of the total contributions received by the charity to the charity's total expenses minus expenses of monies/funds spent on the Charity's mission statement/cause for a given tax period (“FG Expense Number”). Both the Fastgiving Number and the FG Expense Number are standardized objective scores which characterize the charity's fiscal behavior and financial effectiveness. In some embodiments, the performance metrics server includes more than two metrics generators in order to calculate other objective metrics and scores.

Once the performance metrics (e.g., Fastgiving Number, FG Expense Number) have been determined, the performance metrics server transmits the metrics to the one or more user terminals for display. The user terminals may comprise desktops, laptops, tablets, smart phones, or other processor based machines. In some embodiments, one or more of the user terminals have a direct connection with the performance metrics server. In other embodiments, one or more of the user terminals are connected with the performance metrics server over a network.

The user terminal(s) is configured to provide an interface in which a user can send a search request for a particular charity. This search request is transmitted to the performance metrics server, which commands the server to retrieve the necessary financial data/information from the IRS databases (or the memory storage unit) to generate the performance metrics. The generated metrics are subsequently transmitted to the user terminals for presentation in the interface. In some embodiments, the interface is a website/webpage (e.g., www.fastgive.com) through which the user can research information on particular charities. In other embodiments, the interface is a search engine (e.g., Google®, Bing®, Yahoo!®), wherein the user can initiate a search on a particular charity. In still other embodiments, the interface is a dedicated software application, or “App,” on any appropriate computing device. Once the search request is completed, the interface shows a list of search results for the particular charity as well as a brief financial synopsis (presented, for example, at the top of the search result list), which includes the generated performance metrics.

In another embodiment of the present teachings, the system includes, but is not limited to, at least one performance metrics server in communication with one IRS database and at least one user terminal. The single IRS database stores both sets of data/information discussed above with respect to a first IRS database and a second IRS database, e.g., EIN Master CSV file and Finance CSV file.

The method according to one embodiment of the present teachings includes the steps of, but is not limited to, receiving a search request for a particular charity made through an interface at a user terminal, executing the search request in a performance metrics server, establishing a communication link between the performance metrics server and one or more IRS databases to obtain profile, background and financial data on the requested charity, generating a unique identifier for the requested charity, generating performance metrics reflecting the financial effectiveness of the requested charity, and transmitting the generated performance metrics to the user terminal for display in the interface, wherein the performance metrics comprises at least one of the Fastgiving Number or the FG Expense Number.

Other features and aspects of the invention will become apparent from the following detailed description, taken in conjunction with the accompanying drawings, which illustrate by way of example the features in accordance with embodiments of the invention. The summary is not intended to limit the scope of the invention, which is defined solely by the claims attached thereto.

### BRIEF DESCRIPTION OF THE DRAWINGS

FIG. 1 shows the home page of the preferred embodiment of the present invention.

FIG. 2 illustrates how a particular charity is presented in the preferred embodiment.

FIG. 3 shows the preferred embodiment of how a user would make a charitable contribution.

FIGS. 4 and 4A are examples of contribution pages for emergency relief according to preferred embodiments of the present invention.

FIG. 5 illustrates a patron sign-up page;

FIG. 6 shows a charity sign-up page;

FIG. 7 is an example of a social networking page according to the preferred embodiment of the present invention.

FIG. 8 shows a page used by a charity to upload information to its unique standardized charity page;

FIG. 9 illustrates a payment instructions page;

FIG. 10 shows a payment information page;

FIG. 11 is a schematic diagram of one embodiment of a system for generating objective performance metrics of charities in accordance with the present invention;

FIG. 12 is a schematic diagram of one embodiment of the system of FIG. 11, wherein user terminals are connected to the performance metrics server through a network.

FIG. 13 is a schematic diagram of another embodiment of the system of FIG. 11, wherein the performance metrics server communicates with one IRS database.

FIGS. 14a-14b show an exemplary illustration of entry items of an IRS Form 990 Masterfile Extract used by the system of FIG. 11.

FIGS. 15a-15b show an exemplary illustration of entry items of an IRS Form 990-EZ Masterfile Extract used by the system of FIG. 11.

FIGS. 16a-16d show an exemplary illustration of entry items of an IRS Form 990-PF Masterfile Extract used by the system of FIG. 11.

FIG. 17 shows an exemplary illustration of an output file generated by the system of FIG. 11.

FIG. 18 is one embodiment of the webpage of FIG. 2 showing objective performance metrics of a particular charity.

FIG. 19 is one embodiment of a web search engine showing results of a search request for a charity, as well as a brief financial summary including objective performance metrics of the charity.

FIG. 20 is a flowchart of a method according to the present invention for using the system of FIGS. 11-13.

FIG. 21 is a flowchart showing additional steps in the method of FIG. 20 involved with obtaining information from one or more IRS databases.

FIG. 22 is a flowchart showing additional steps in the method of FIG. 20 involved with generating performance metrics using metrics generators.

### DETAILED DESCRIPTION OF THE INVENTION

The following description illustrates the invention by way of example, not by way of limitation of the principles of the invention. This description will enable one skilled in the art to make and use the invention, and describes several embodiments, adaptations, variations, alternatives and uses of the invention, including what we presently believe is the best mode of carrying out the invention.

U.S. patent application Ser. No. 12/649,346 (Publication Number US 2011/0071907 A1), teaches a means and method of facilitating charitable contributions through an interactive social media networking community website with advertising, contribution, and distribution functions. This invention is designed to maximize charitable contributions and allows for a tailored distribution scheme that supposedly more effectively raises and distributes charitable contributions. This disclosure differs from the current invention in that it does not provide a competitive marketplace with standardized information where charities compete for contributions and where potential patrons can access centrally organized data bases of charities with standardized financial metrics which make it possible to evaluate the relative quality of charities. U.S. patent application Ser. No. 12/649,346 (Publication Number US 2011/0071907 A1) also differs from the present invention in that one of its principal objectives is to engage celebrities, athletes, politicians and other publicity-seeking individuals to provide free advertising for charitable organizations.

Other examples of charity-related websites are Charity Navigator (www.charitynavigator.org), Just Give (www.justgive.org), and Network for Good (www.networkforgood.org). These sites however do not provide a competitive and standardized marketplace for charitable transactions within a social network, they do not relate charities to financial type ratio metrics similar to Price to Earnings (P/E) ratio etc, they do not offer standardized charity pages to promote an ease of comparison for patrons to understand a charity's specifics and easily differentiate one charity from another. They further do not provide a central clearinghouse for disaster relief, such as giving patrons current news from an emergency, while simultaneously giving the patron an immediate way to contribute funds to a number of charities simultaneously to address the needs of that emergency on a web page or with a tablet or smart phone application. The prior art also does not allow for charities to interact with its own and potential new patron bases, whereas the present invention builds an interactive social networking or Facebook-type community for charitable activities. The prior art does not allow a charity to invite or solicit patrons who are members of the site, but not a current contributor to their charity.

Preferred embodiment. In the context of its basic method, the present invention's most basic embodiment is software programs, applications, and engines, especially in connection with the internet, providing user interfaces accessible by computer, tablet, or smart phone. A particular embodiment is a web application using a web browser as a (thin) client. This embodiment allows for centralized orderly charitable contributions and potentially makes e-philanthropy more easily accessible to the world's two billion internet users.

In a preferred embodiment, a charity registers itself on the website by providing qualifying information, while a patron signs up for an account. Once the patron account is established, the patron can then search, select, and contribute to a charity. Charities can message, <<friend request>>, or invite the patron to join its patron base. An embodiment of the invention can in some sense be thought of as a ‘social networking engine (such as Facebook) for charities and patrons’, allowing charities to communicate with and raise funds from their patron base, and potentially other patron bases in our social network. In other embodiments, the system identifies and lists all charities available to it regardless of whether each charity registers.

It is important to understand that charity pages of the exchange described herein are always open, searchable, and directly accessible by all internet public, and are not accessible only through the page hierarchy of the basic website. For example, if one were to Google the Red Cross, which would likely be a member of the exchange, the Red Cross would come up as a search result alongside the name of the exchange, making it likely that the patron will make a contribution through the central clearinghouse service of the exchange.

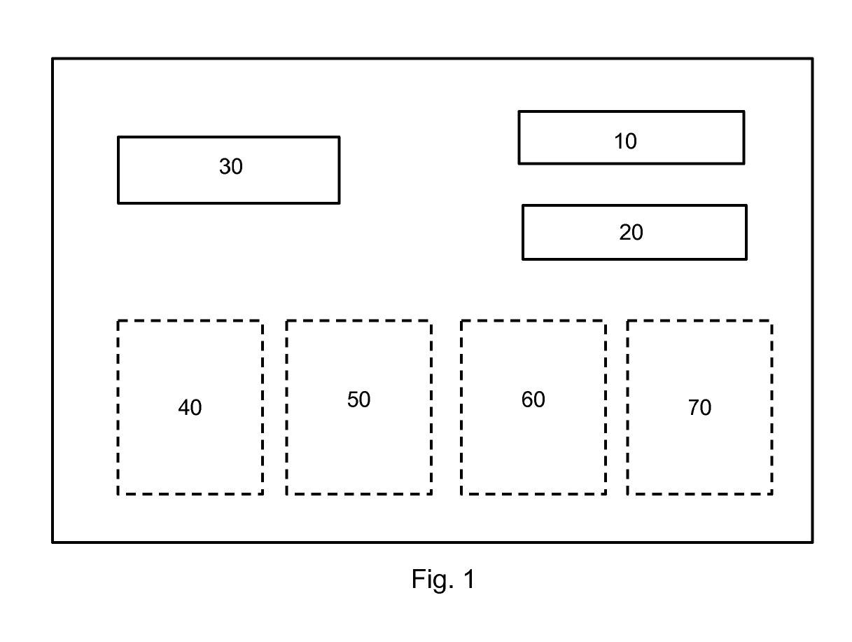

Referring now to the drawings, in which like reference numbers represent similar or identical structures throughout, FIG. 1 shows the basic graphical user interface for the homepage of the internet site. This homepage can be accessed in various ways: directly entering the domain name into a browser window; going through a search engine such as Google or Yahoo; by way of an affiliate program link to the homepage from a banner on a different internet site. On the homepage traditional login boxes for username 10 and password 20 allow an account holder to log in to her account (stored on a central server, not shown). A charity search is driven from a search dialogue box 30 wherein the potential patron can enter a search term, which could be either the name of a specific charity or general phrase such as <<cancer>>, <<environment>>, or other charity-related terms. Descriptions of how to set up an account 40, find a charity 50, choose a direct charity 60, and how to choose and to contribute to a sponsored portfolio 70 of charities like a stock mutual fund, which allows a patron to contribute to a general cause like cancer that covers several charities, are also present on the page.

In other embodiments, the user can search for charities based on the objective metrics. For example, the user can enter a particular Fastgiving Number and/or FG Expense Number and get a list of charities with that exact metric. In other embodiments, the user can enter a range of values from a minimum to a maximum of the metrics to be searched and get a list of charities with metrics that fall within the range.

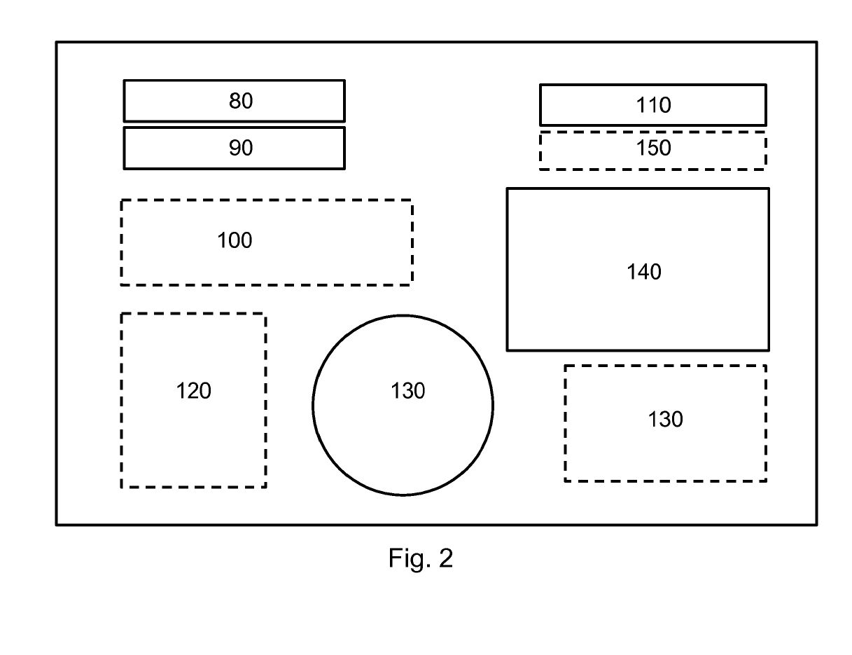

Once a potential patron has entered a search, a different webpage will appear, as shown in FIG. 2. This page provides the name(s) 80 of the found charity, and its basic focus 90 and mission 100. It also displays a unique code/ID 110 for that specific charity, similar to a stock ticker symbol. The page also lists information about how the charity uses its donations 120 and provides a budgeting and accounting breakdown 130, which includes displaying charity specific metrics, allocations to administration, advertising, fund raising, operations, etc. The legal status of the charity, its country of origin, and the name of its accountant are also displayed. This serves an important vetting function and tells the user about the caliber and legitimacy of the charity. Charities that meet exceptionally high standards qualify for special certification status, which is indicated graphically to the user (not shown). The page also provides access to further information about the charity such as YouTube video clips 140, or pictures, live video streaming, etc. The information described above help potential patrons make informed donation decisions, and allows them to select charities with a low expense ratio, for example. A clickable link 150 lets the user add the charity to her portfolio of charities. The link 150 will either bring up the user's updated portfolio, or direct the user to a login page or a sign-up page if the user is not currently a member of this social network. Once the charity has been added to the portfolio, the user can make a donation to it.

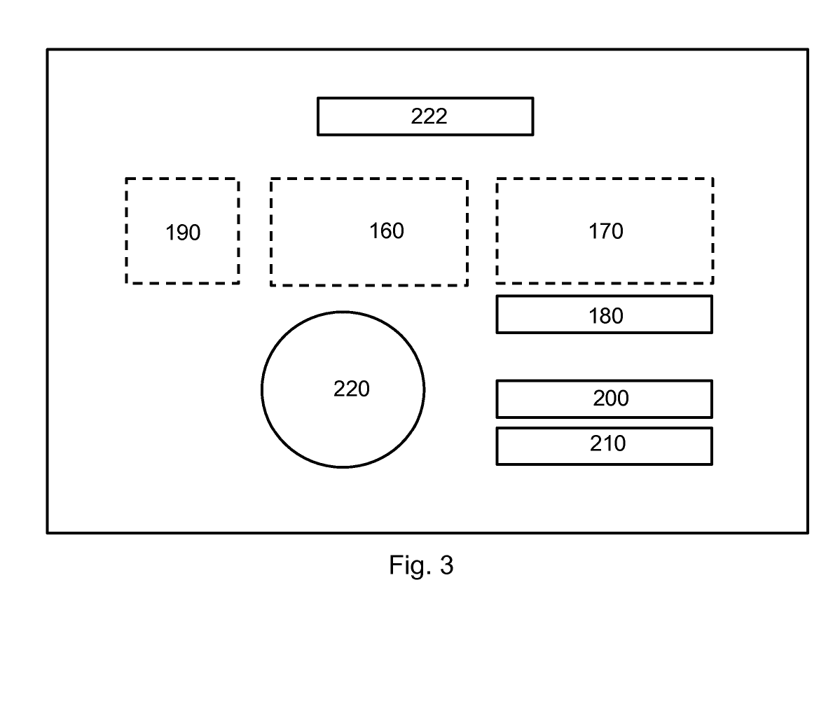

The portfolio page, as shown in FIG. 3, presents a portfolio list 160 of the charities to which a particular patron typically donates. Dialogue boxes 170 let the patron make new donations in desired amounts, which are automatically summed to a total 180. The portfolio page also displays the patron's account information 190, the patron's total donations for the current year 200, and her total cumulative contributions 210. A pie chart 220, or similar graphical representation, of how donations have been allocated across charities in the portfolio, is also displayed. There is also a way to add a new charity 222 to the portfolio 160. There is also a message link (not labeled) on the page, allowing for social networking functions and communication links such as intra-site email.

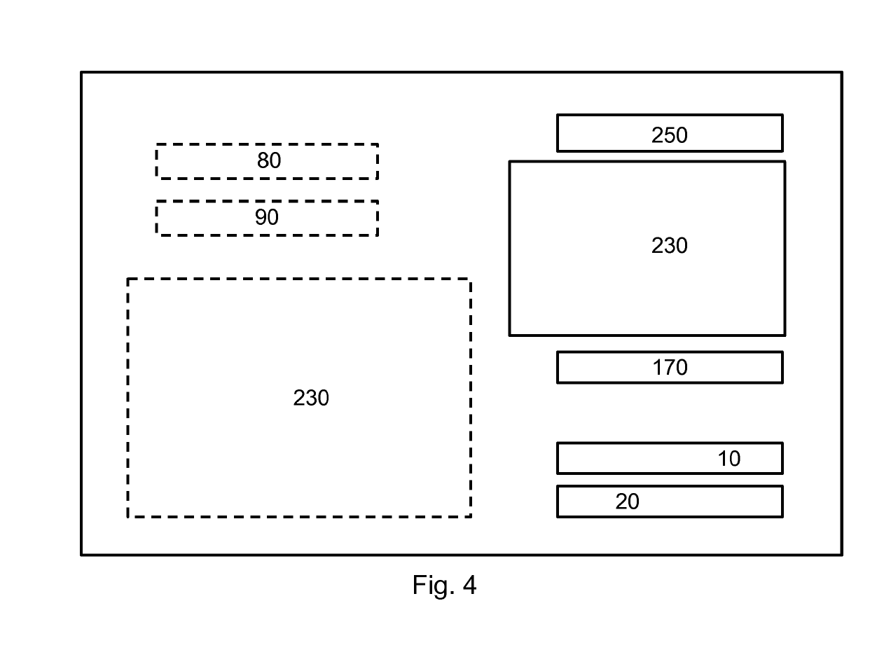

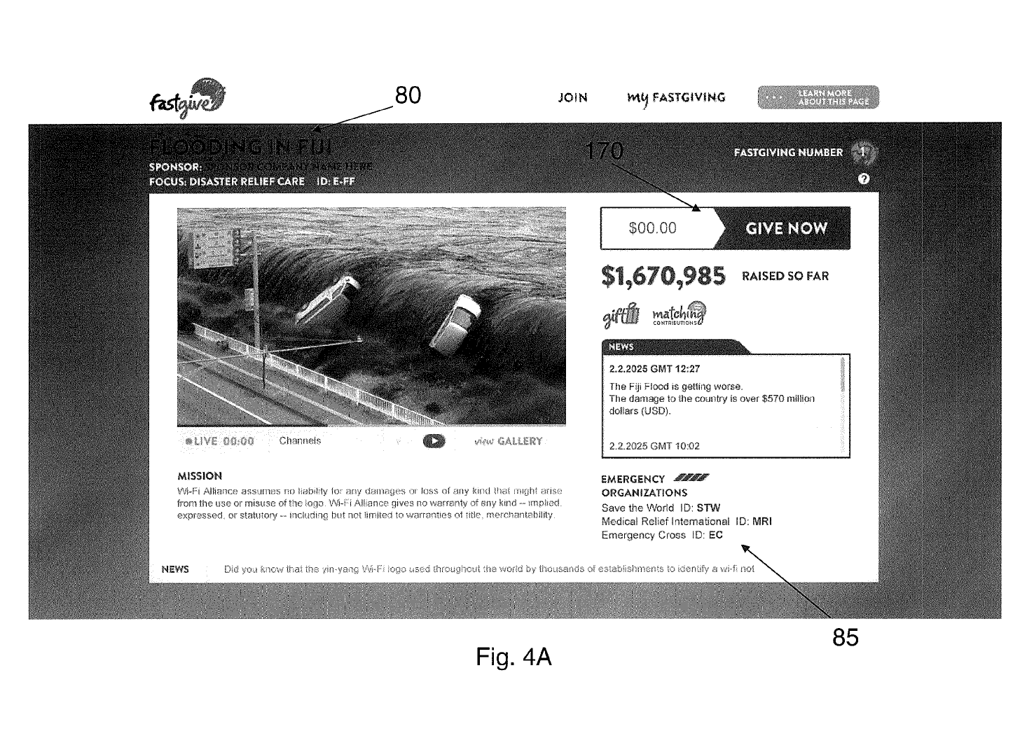

A further feature of the preferred embodiment is a page dedicated to contributions and donations intended for emergency causes, such as disaster relief, etc, as seen in FIG. 4. Potential patrons can access this page through any of the other pages on the website by way of icons or banners present on each one of these pages, or directly through a search engine such as Google or Yahoo. The page displays the Emergency's name 80 (the names of a charity or several charities may also be displayed, in which case a determination will be made about the relative contributions to each charity), its focus 90, and a live news feed 230 about the emergency, which could include text and video feeds, Twitter links and feeds, blog links, YouTube video messages, etc. A donation box 170 allows the user to enter a desired contribution amount, and a running total 250 of the amount raised from all patrons is displayed. Patrons can thus contribute to a particular emergency through several charities focused on that emergency, with real time news and information regarding that emergency.

FIG. 4A shows a webpage such as that described above according to an exemplary embodiment in which a group of charities involved in emergency relief efforts have been “basketed” together. The webpage includes a listing 85 of the charities involved in the relief efforts for an emergency 80. The webpage also includes a donation box 170 in which a user can enter a donation amount alongside a clickable button for submitting the donation.

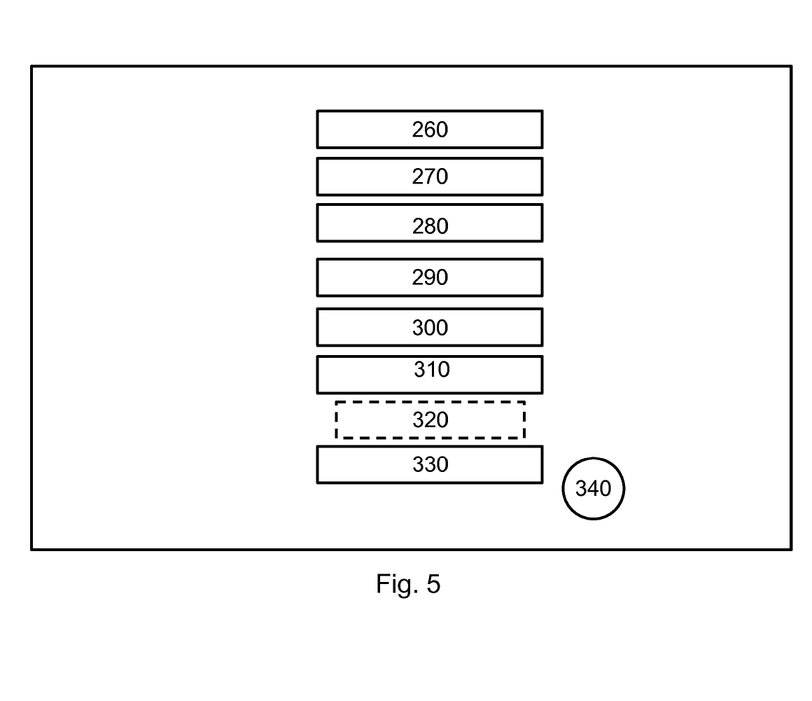

A specific patron sign-up page, as shown in FIG. 5, allows a patron to enter last name, first name, username, password, password confirmation into boxes 260, 270, 280, 290, 300, 310. Also shown is a CAPTCHA code 320, code entry box 330, and a submit button 340.

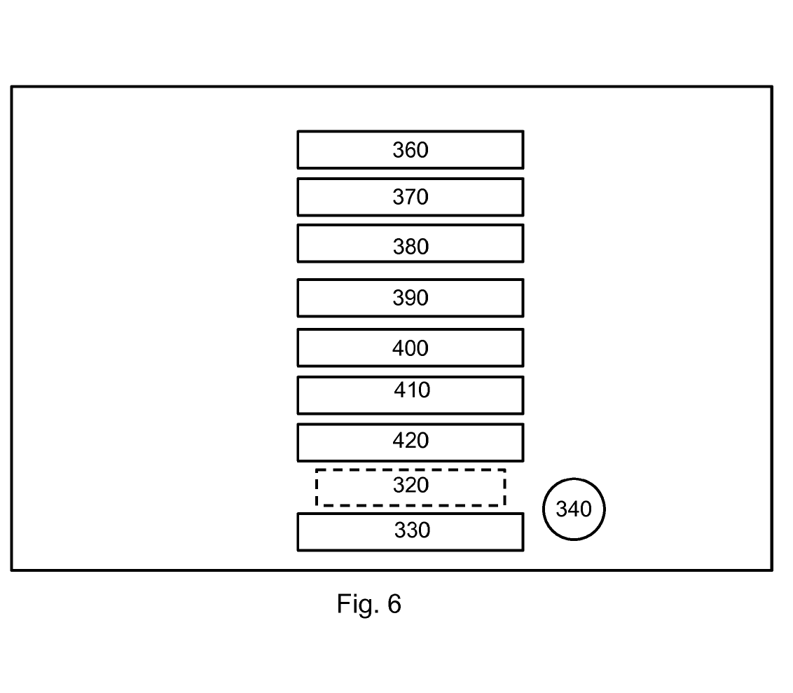

Similarly, a charity sign-up page (FIG. 6) lets charities enter name, identifier such as an EIN number or, in some embodiments, a 501(c)3 non-profit organization number, contact info, username, password, password confirmation, and country into boxes 360, 370, 380, 390, 400, 410, 420. A CAPTCHA code 320, code entry box 330, and a submit button 340 are also included. In some embodiments, the system automatically checks the EIN against the IRS database to make sure the subscribing entity is a charity. In some cases, the charity does not have an identifier like an EIN. In such cases, the charity can attest to its status.

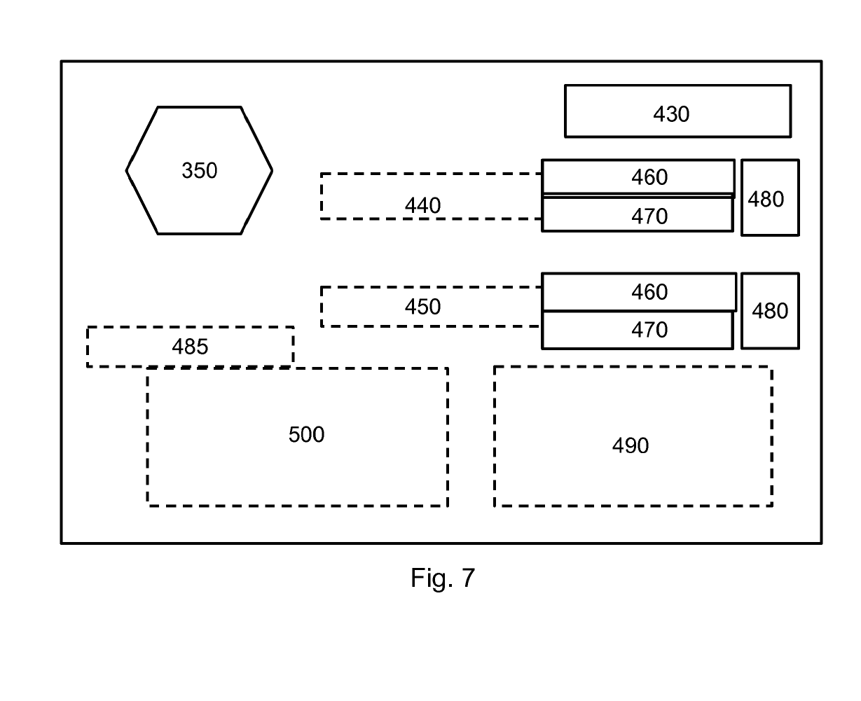

FIG. 7 shows a social networking page which provides a search box 430 and lists certain relevant charities 440, 450 and topic lines 460, 480. Next to each charity is a box 460 allowing a user to “Read an existing topic”, a box 470 to “Start a new topic” or start a new online community, and a drop-down menu 480 showing top topics. Once a topic 460 or 480 is chosen (clicked on) or a new topic or online community is added 470 the topic or online community name will appear in box 485. There is also a box to enter text 490 and a box 500 which displays an ongoing discussion.

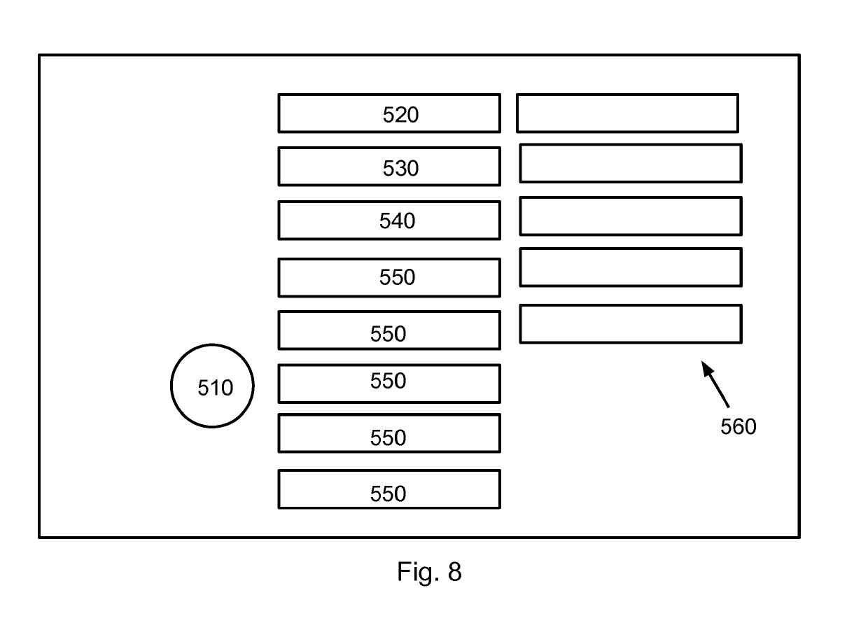

The charity personalized page (FIG. 8) allows a charity to upload information, pictures, and videos it would like displayed on its unique standardized charity page. It includes a mission statement 520, a YouTube clip and recorded events video 530, charity focus 540, and various information about the charity and fund allocations, contribution allocation, expenses, accounting firm information, with corresponding boxes 550 (with an upload button 510). There is also a list 560 where a charity enters the top ways in which contributed funds are used by the organization. A button 510 allows the charity to submit the information to the website operator for display on the charity's unique standardized charity page.

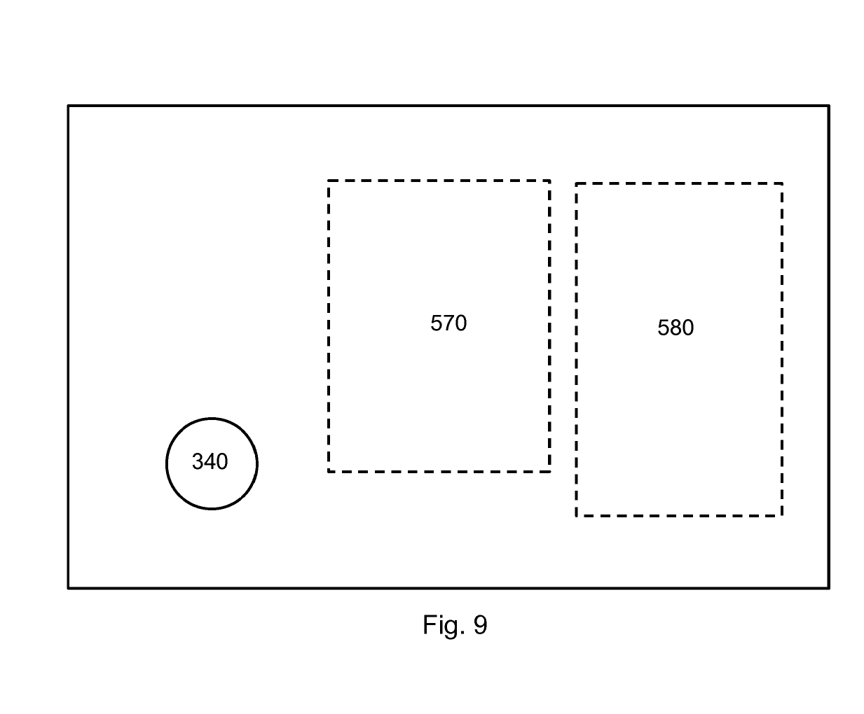

A charity receivables instruction page, as illustrated in FIG. 9, has a field 570 which allows a charity to enter electronic wiring information such as account name, routing number, account number, bank name, bank address, and bank phone number, and another field 580 which allows a charity to enter physical delivery check payment information such as name, contact, and address and submit said receivables information to the web site with a submit button 340.

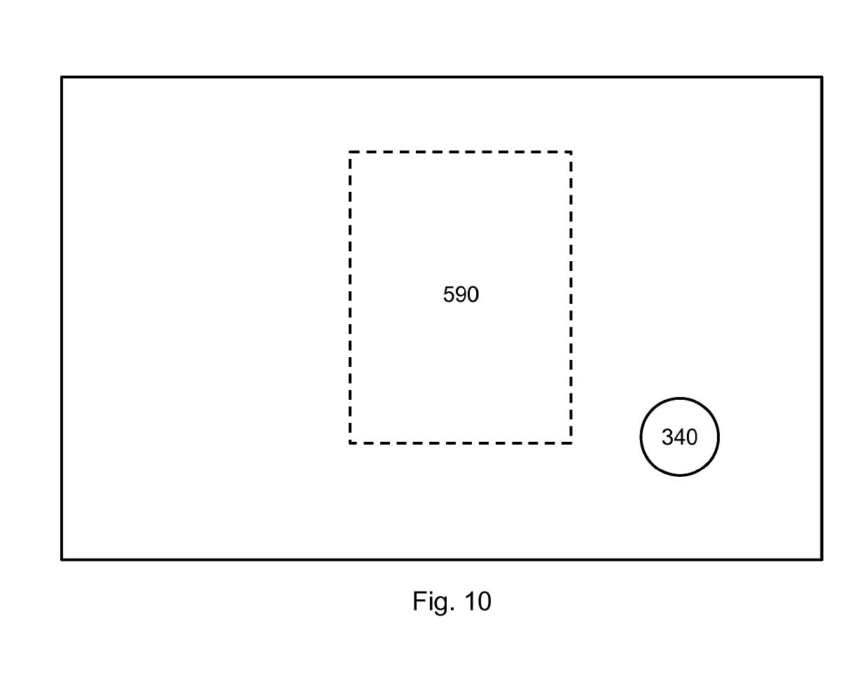

A payment information page, FIG. 10, allows a patron or charity to enter standard credit card information such as card type, account number, cardholder name, expiration date, CSC number, etc. or other forms of payment information such as electronic check or Paypal information into field 590 and submit said payment information to the web site with a submit button 340.

The preferred embodiment of the present invention also includes a mechanism for contributing to multiple charities in single action by making a contribution to a predetermined portfolio. Such a predetermined portfolio is a preselected basket of charities, much like a stock mutual fund, within a certain sector, such as <<peace>>, <<poverty>>, <<children>>, or as designated by a sponsor such as a corporation who has a list of preferred charities they give to on an ongoing basis, etc. In the same way as the purchaser of a mutual fund achieves investment diversification through the single purchase of a fund which has been assembled by professionals, a potential patron can spread the benefit of their contribution across multiple charities while avoiding the laborious process of finding and making contributions to each individual charity.

The present invention also allows charities to sign up for priority services which would give them preferential advertising positioning through sponsored links, as is common practice with search engines such as Google. Charities can also sign up for programs designed for emergencies such as disaster relief, etc. Further, a charity can sign up for exclusive status which affords them the advantage of marketing directly to registered patrons not currently in their patron base for that particular charity. Another feature of such exclusive status is a specific identifier, such as a different ticker symbol preferred by the charity, making it easier for high profile charities to identify themselves to patrons. In general identifiers will be available on a first come first serve basis.

The present invention further lets a patron or a charity start an online community, which is somewhat similar to creating social networking groups. A patron or charity can set up a unique page where other like-minded patrons and charities can join together to discuss and support a cause.

The present invention also features invitations to join a charity. Registered charities have the opportunity to issue invitations to potential patrons with a certain patron profile and contribution history. In some embodiments, a charity has access to patron lists through the online marketplace. A charity thus invites the patron by giving the patron a link to their charity page, and if the patron is interested, the invitation is accepted by clicking on the link on the charity's page to add the charity to the patron's portfolio, much like friend invitations are accepted on social networking engines, such as Facebook.

Invitations to specific events are also within the scope of the current invention. Charities can invite their patron base to specific events or fundraisers through direct invitations electronically sent to the patron and through the social network. For terrestrial events, patrons can receive free tickets or purchase tickets, transportation, and living accommodations through the marketplace, or make contributions online in case the patron cannot physically attend the event. The present invention also lets charities provide live video, and news feeds from such events, along with real time fundraising updates.

With the present invention, charities are further able to host auctions for fund-raising purposes. In an auction, a charity lists auction items, which could be goods or services, and electively has the option to set a reserve price and termination date, similar to online auctions conducted on sites such as eBay, or in real time like Sotheby's Auction House.

A significant advantage of the marketplace model of the present invention is that transaction fees can be charged for the clearing of contributions, very much like transaction fees are charged for buying and selling stock on an exchange. This opens up a unique avenue to funding, which obviates needs for membership fees from patrons, basic services fees from charities, and banner advertising fees.

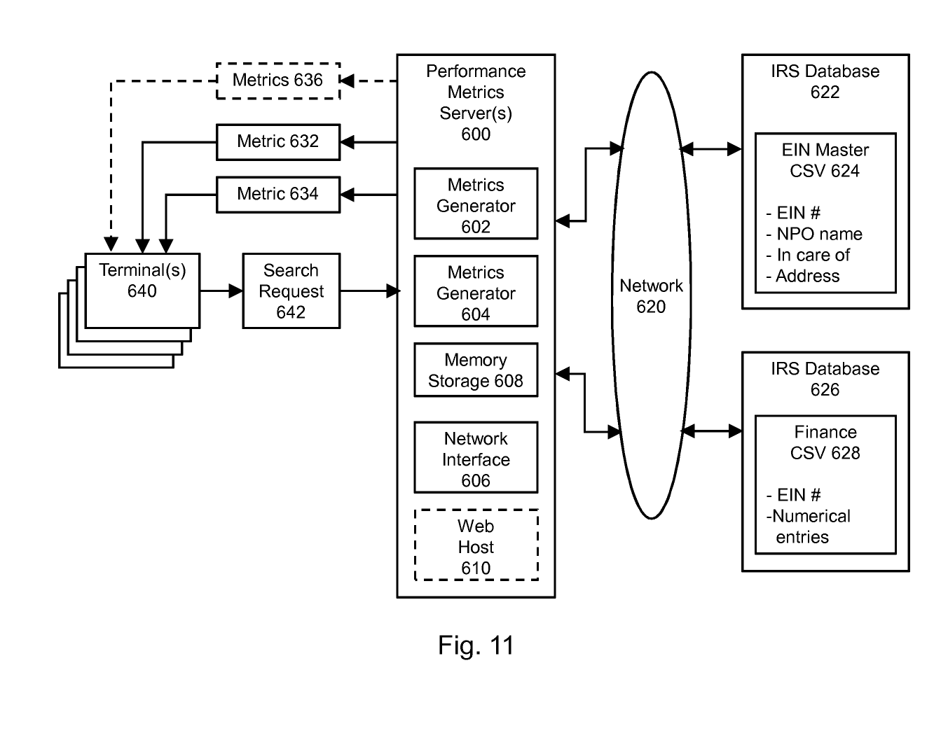

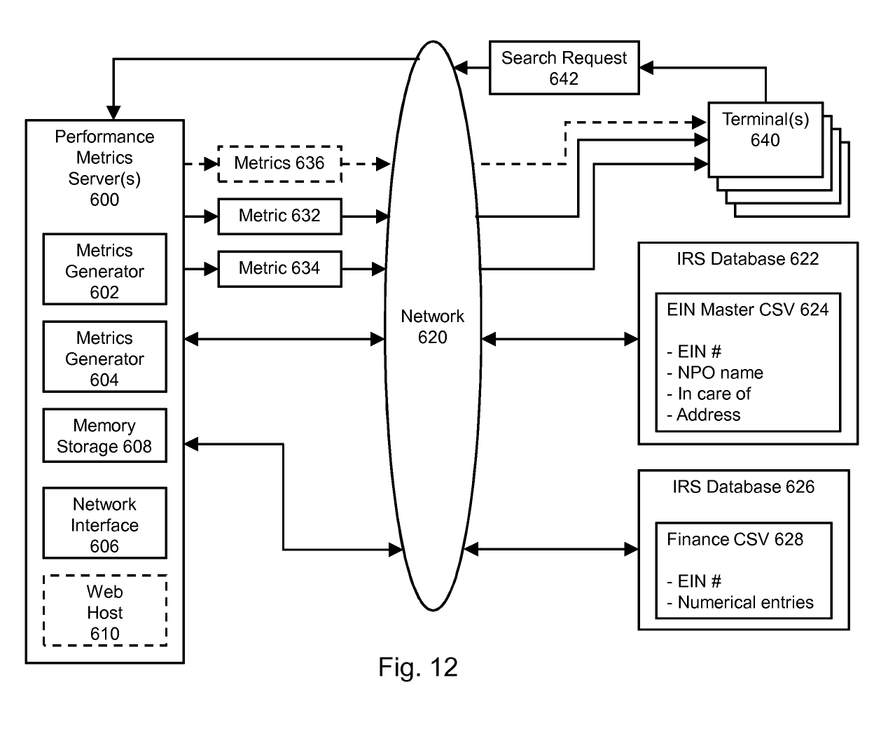

Referring to FIG. 11, there is shown an exemplary embodiment of a system for generating objective performance metrics reflecting the fiscal behavior and financial effectiveness of a charity. The system includes at least one performance metrics server 600 in communication with one or more user terminal(s) or workstation(s) 640. The terminal(s) 640 may comprise a desktop, laptop, tablet, server, smart phone, or other processor based machines. As shown in FIG. 11, the terminal(s) 640 may have a direct communication link with the performance metrics server(s) 600. Alternatively or in addition thereto, the terminal(s) 640 may connect with the performance metrics server(s) 600 through a network 620, such as a LAN, WAN, MAN, or the Internet (see FIG. 12).

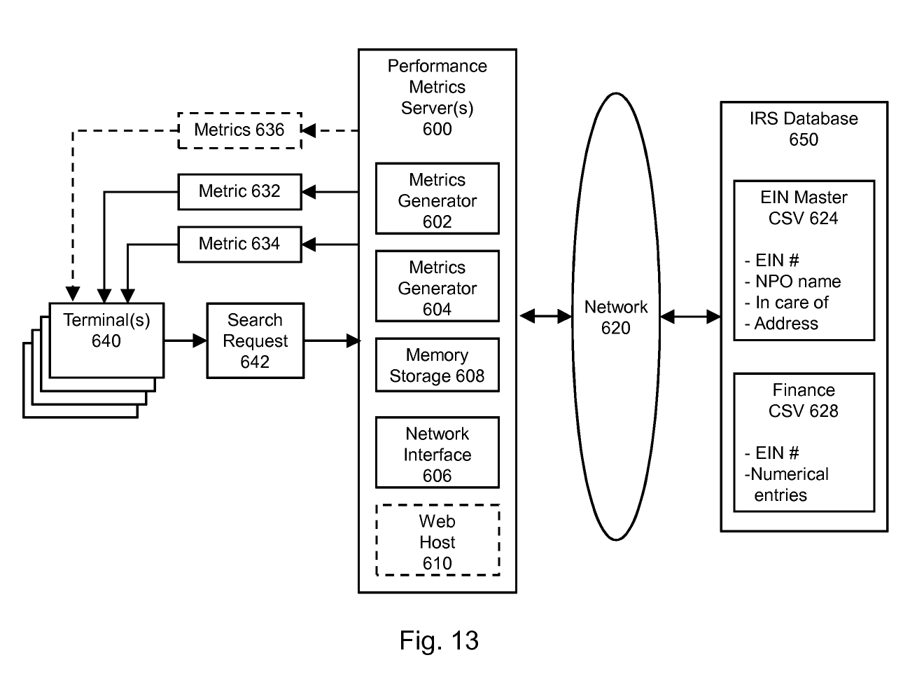

The system is also configured to be in communication with two or more IRS database units 622, 626 (e.g., computers, servers) in order to obtain profile, background and financial data on charities, wherein such data is collected by the IRS through tax filings submitted by the charities. For simplicity, FIG. 11 shows two IRS databases 622, 626 communicatively connected to the performance metrics server(s) 600 through the network 620. In other embodiments, the system communicates through network 620 with only one IRS database 650, which contains all profile, background and financial data on charities in the United States (see FIG. 13). In other embodiments, the system is in communication with one or more databases that are not owned by the IRS but are, instead, owned by one or more tax collecting entities. In still other embodiments, the system is in communication with one or more databases owned by one or more private entities.

As shown in FIGS. 11 and 12, a first IRS database 622 contains profile and background information on each charity, including the charity's official name, employer identification number (EIN) assigned by the IRS, agent/contact name (e.g., in care of), and main address. This information is maintained in a comma separated values (csv) format, for example an EIN Master CSV 624. A benefit of the csv formatting is that a large amount of information can be easily and quickly transmitted and processed (e.g., read, write) by any program, such as a spreadsheet application, word processor, or simple notepad application. However, in other embodiments, the information stored in the first IRS database 622 may be formatted using an extensible markup language (xml), spreadsheet format (e.g., xls), a generic text format (e.g., txt), other file formats (e.g., compressed file). A second IRS database 626 stores data of each charity's finances. In particular, the second IRS database 626 includes financial data submitted by charities to the IRS in periodic reporting returns (which are required to be filed by most organizations that meet the requirements of Internal Revenue Code 501(c)(3) such that they are exempt from income tax under Internal Revenue Code section 501(a)), such as IRS Forms 990, 990-EZ, and/or 990-PF. The financial data of each charity is managed and identified/associated with each charity's EIN number. Like the first IRS database, the second IRS database may format the financial data stored therein in a csv structure, or Finance CSV 628. Alternatively, the second IRS database 626 may organize the financial data of each charity in an xml structure, spreadsheet format (e.g., xls), generic text format (e.g., txt), other file formats (e.g., compressed file format).

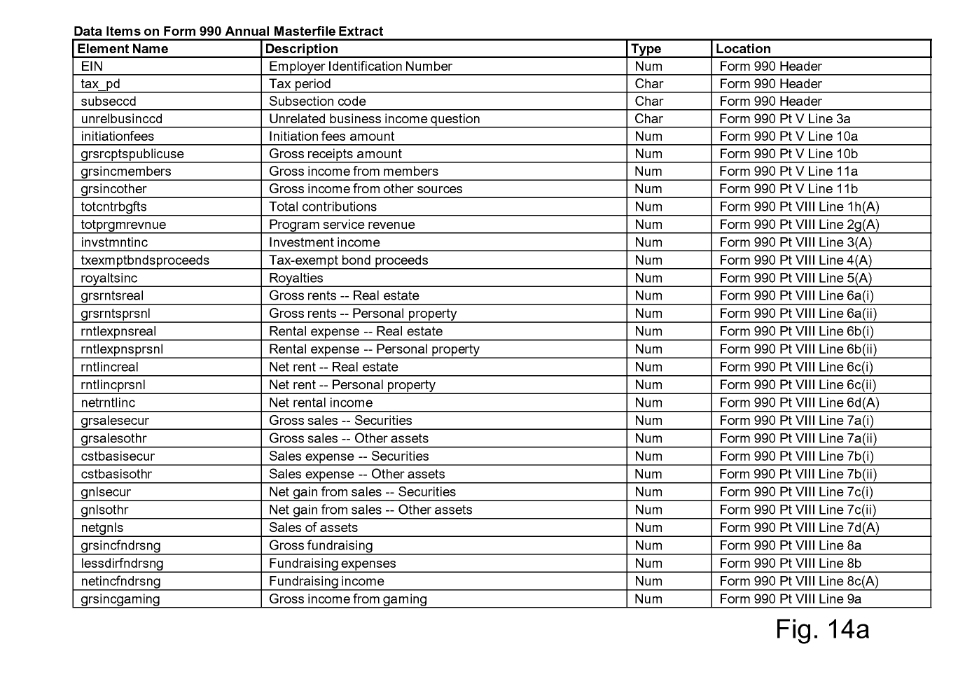

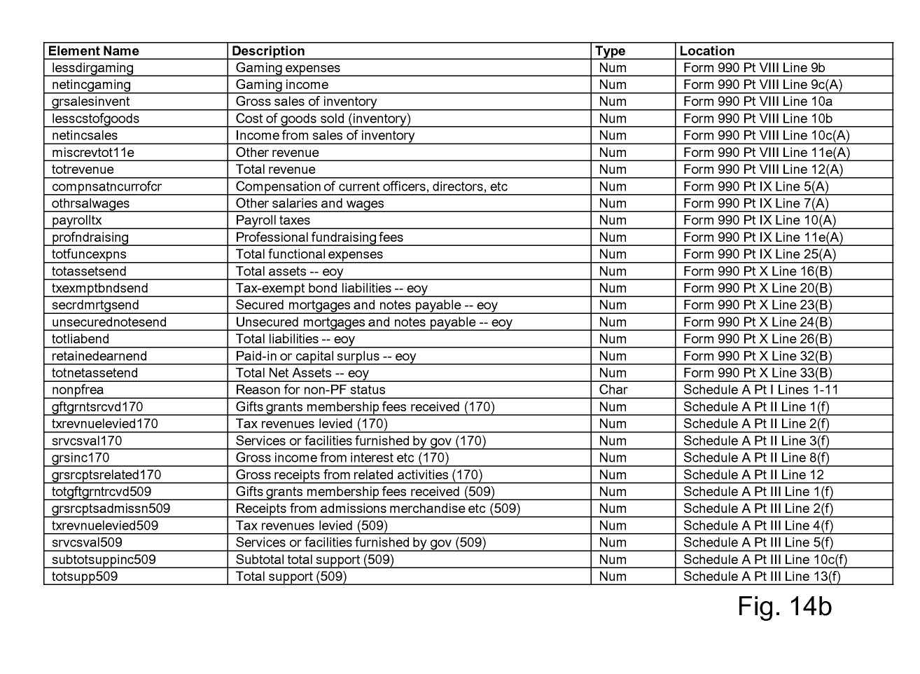

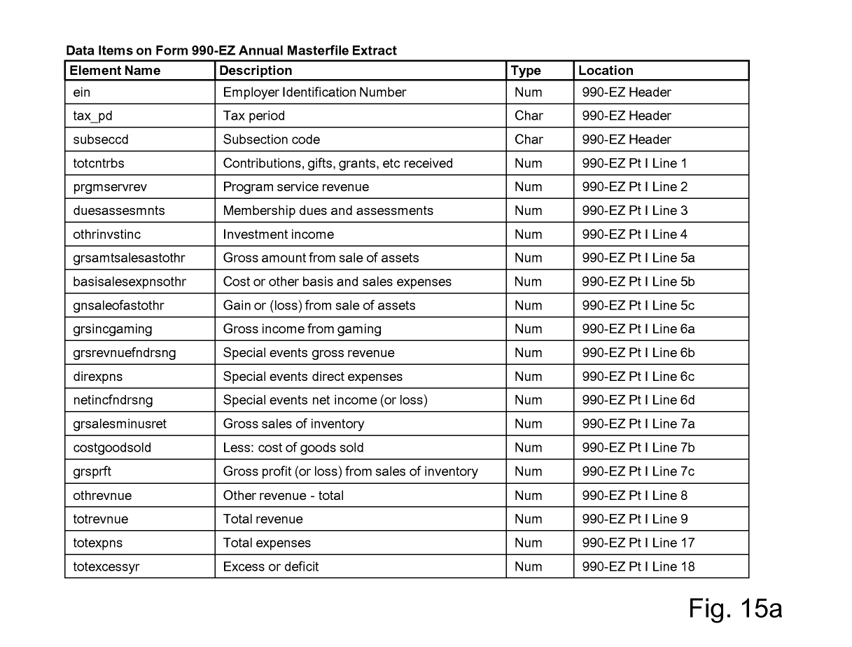

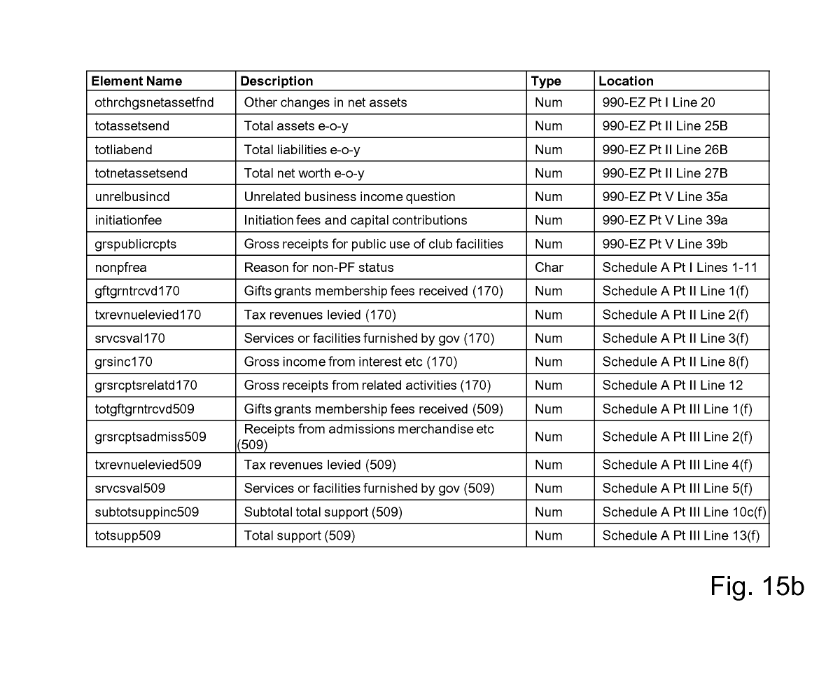

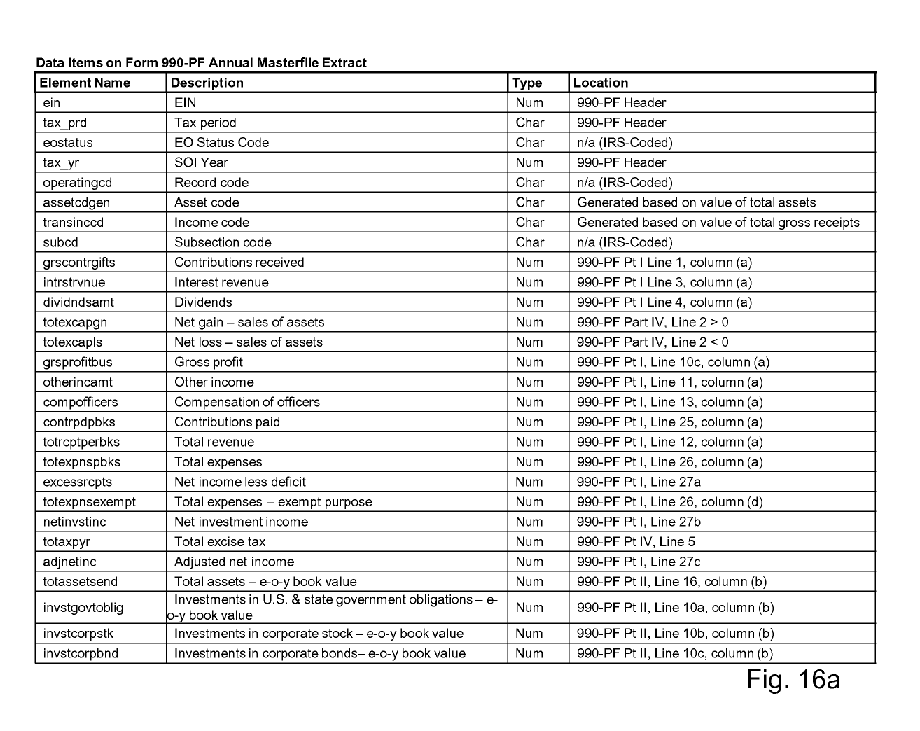

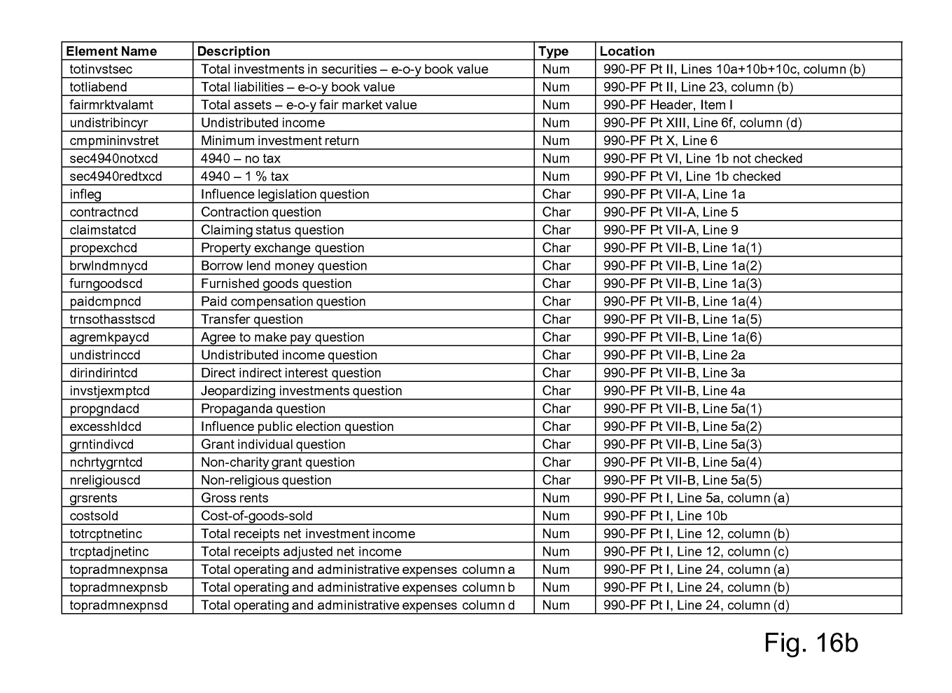

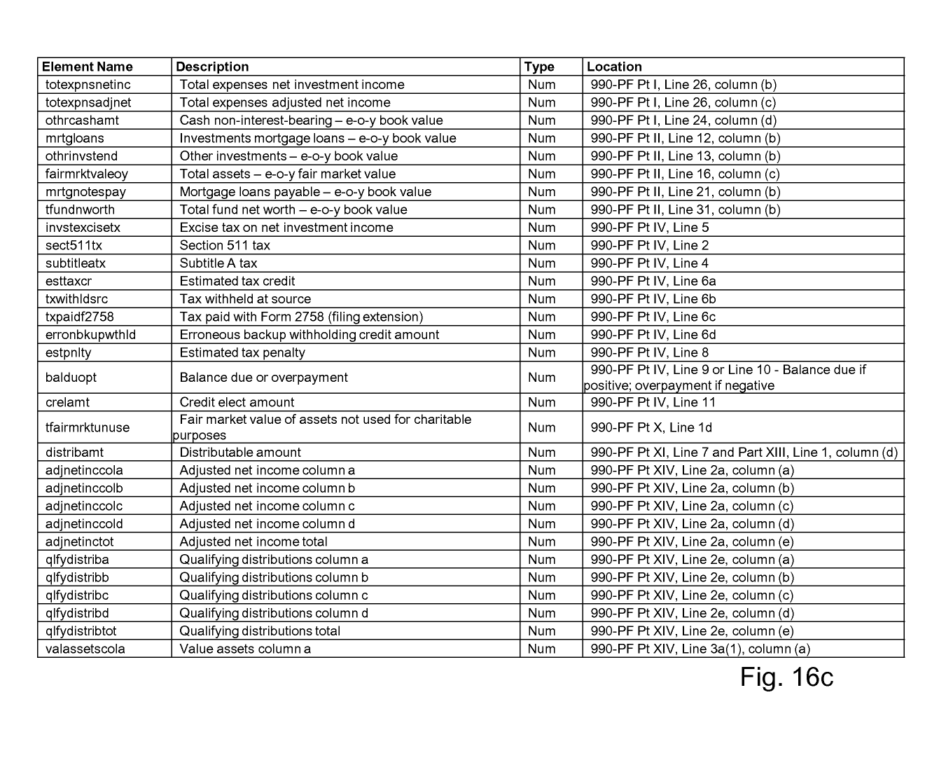

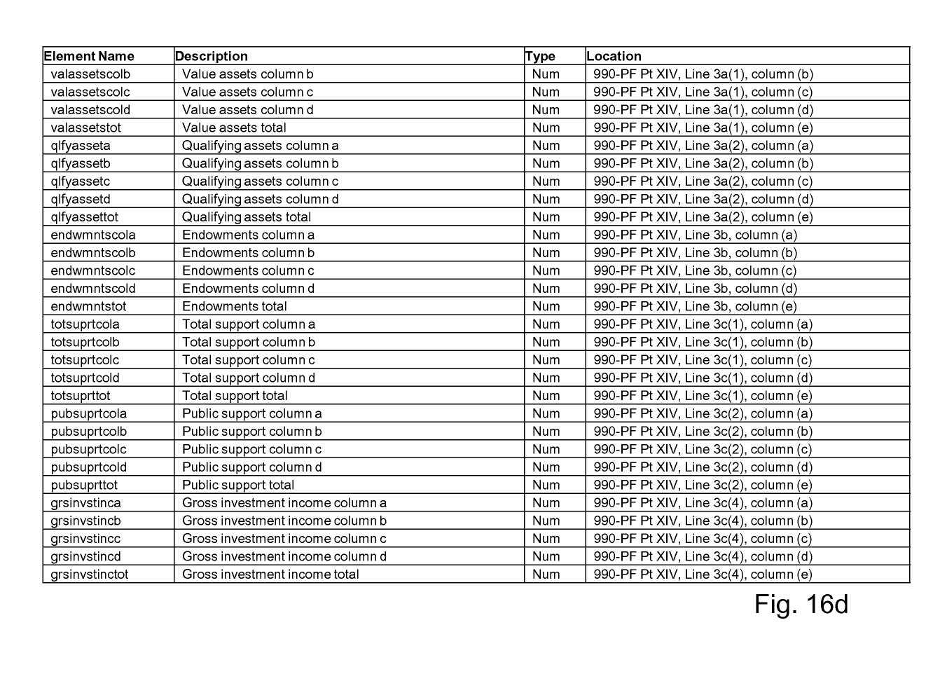

FIGS. 14a-14b, 15a-15b, and 16a-16d variously show financial data collected and stored in the second IRS database 626 from IRS Forms 990, 990-EZ, and 990-PF, respectively. Such information comprises, but is not limited to, tax period, the total amount of contributions received by the charity in a given tax period (e.g., income from direct and indirect revenue sources received by the charity), the total amount of contributions spent by the charity in the given tax period (e.g., amount of direct and indirect revenue paid for goods and/or services directed to the charity's mission or cause)—including the amount of grants/endowments to the government, the amount of grants/endowments to individuals, and the amount of grants/endowments to foreign governments—, as well as the charity's total operating expenses for the given tax period. Other financial information within the second IRS database 626 include investment income, royalties, gross rents—real estate, gross rents—personal property, rental expanse—real estate, rental expense—personal property, net rent—real estate, net rent—personal property, net rental income, gross sales—securities, gross sales—other assets, sales expense—securities, sales expense—other assets, net gain from sales—securities, net gain from sales—other assets, sales of assets, gross fundraising, fundraising expenses, fundraising income, other revenue, total revenue, compensation of current officers, directors, trustees, and key employees, and other salaries and wages.

Referring back to FIG. 11, the system—for example, the performance metrics server 600 or metrics generators 602, 604—is configured to generate a unique public identification code (110 in FIG. 2) for the charity. This generated public identification code is different from the employer identification number assigned by the IRS. The generated public identification code, which resembles a stock ticker symbol, uniquely identifies the charity for purposes of conducting transactions between potential patrons and charities (e.g., patrons submitting contributions to a charity). The public identification code—or “Public ID”—can be generated using one of a variety of ways. In some embodiments, the Public ID is randomly generated according to rules such as length, restrictions on acceptable character sequences and repletion etc. In other embodiments, the charity can pay a fee to buy a specific ID that is important to it. In some embodiments, the system uses codes for categorizing various IDs, such as “NPO” for non-profit organization, “SP” for sponsor, “E” for emergency, “IN” for initiative, in connection with each entity's ID, e.g., “NPO—[ ][ ][ ].”

Additionally, the public identification code may be used by the system to associate generated performance metrics with a specific charity. The system has two metrics generators 602, 604 for analyzing the finances of a charity and determining objective performance metrics related to the financial effectiveness of the charity, and further a memory storage unit 608 for local storage of the financial data and the generated performance metrics of the charity. The system also comprises a network interface control unit 606 for establishing the communication connections/links between the performance metrics server(s) 600 and the IRS databases 622, 626 (or IRS database 650 in FIG. 13) as well as the communication connections/links between the performance metrics server(s) 600 and the one or more user terminal(s) 640, and further monitors the status of the connections. The network interface 606 comprises any standard hardware and/or software for connecting and communicating between devices. As shown, the performance metrics server 600 is configured to receive a search request(s) 642 from the one or more terminal(s) 640, wherein each search request is a query for information on a particular charity (“requested charity”). Once the search request 642 is received, the server 600 begins the process of analyzing the finances of the requested charity and generating standardized financial metrics. Also, in other embodiments, users can search using specific values or ranges of values of one or more of the metrics 632, 634, 636. The system will also permit searches for public IDs instead of charity name.

Specifically, upon a search request being made, the network interface control unit 606 establishes a communication link(s) through the network 620 to the first IRS database 622 and second IRS database 626 shown in FIG. 12 (or IRS database 650 in FIG. 13). After the link(s) are achieved, the performance metrics server 600 transmits a signal to the databases 622, 626 to gain access to the information stored on the databases. The server 600 first searches, using the charity's EIN, the first IRS database 622 to obtain the EIN Master CSV 624 corresponding to the requested charity. (It will be apparent to those of skill in the art that, in other embodiments, an identifying code other than an EIN will be used to collect the relevant information about the charity from the database(s)). The server then uses the EIN and searches the second IRS database 626 to retrieve the Finance CSV 628 having an EIN which matches that of the requested charity. In one embodiment, the memory storage unit 608 saves the EIN Master CSV 624 and Finance CSV 628 of the requested charity for later use. The generators 602, 604 then read the Finance CSV to locate specific data entries to generate standardized metrics that provide objective scores of the charity's financial effectiveness. To properly locate the necessary data to generate the standardized metrics, the generators use the extract files shown in FIGS. 14a-14b, 15a-15b, and 16a-16d. These extract files are uploadable into the performance metrics server(s) 600 and can be updated periodically (e.g., yearly basis with each new tax year) to account for any changes made to the IRS Forms 990, 990-EZ and 990-PF, or any future tax forms. In case of an organization that may not have an EIN, such as a religious organization, the organization itself will enter its information needed to generate the metrics.

The metrics generator 602, in particular, is configured to generate an objective (non-subjective) score 632 showing how effective the charity is in conducting business for promoting its cause/mission. That is, the metrics generator 602 determines a metric 632 which describes the charity's effectiveness in dispersing funds (contributions) for goods and services directly related to the charity's cause/mission. The metric 632, also known as a “Fastgiving Number”, is characterized as follows:

$$Fastgiving Number = \frac{{C}_{R}}{{C}_{S}} = \frac{{C}_{R}}{( {E}_{G} + {E}_{I} + {E}_{F} )} \qquad ( 1 )$$

wherein CR is the total amount of contributions received by the charity in a given tax period (e.g., current tax period), and Cs is the total amount spent by the charity towards its cause/mission in the given tax period. The total amount spent towards the charity's cause/mission, C_{S}, can be calculated from the sum of the total grants given to the government (E_{G}), the total grants given to individuals (E_{I}), and the total grants given to foreign governments (E_{F}). Values for C_{R}, E_{G}, E_{I}, and E_{F} can be obtained from the Finance CSV 628 originating from the second IRS database 626. (The Fastgiving Number will be expressed differently (i.e., other than as CR/(EG+EI+EF)) with respect to future tax forms while still providing analogous objective information about the quotient of the total amount of contributions received divided by the total amount spent by the charity towards the charity's cause/mission.) The closer the metric 632 (Fastgiving Number) is to 1.0, the more the charity gives to its cause. Thus, it should be each charity's goal to achieve a Fastgiving Number close or equal to 1.0, thereby indicating that the charity effectively uses the funds/income received from direct and indirect revenue sources to pay for goods and services in advancing its cause/mission. In some situations, a charity may exhibit a Fastgiving Number less than 1.0. This outcome arises if a charity spends more towards its cause/mission than the amount it received in contributions within a given tax period, which is possible when the charity uses contributions received from previous tax periods for payment of goods and services. If a charity has a Fastgiving Number of 0, this means that the charity did not give any funds to its cause/mission in that year.

The metrics generator 604 is configured to generate an objective (non-subjective) score 634 showing how efficient the charity functions by lowering overhead expenses and giving more to its cause/mission. A charity with lower expenses will be more competitive than a charity with higher expenses and which gives less to its cause or mission statement. The metric 634, also known as a “FG Expense Number”, is characterized as follows:

$$FG Expense Number = \frac{{C}_{R}}{X} = \frac{{C}_{R}}{{E}_{O} - ( {E}_{G} + {E}_{I} + {E}_{F} )} \qquad ( 2 )$$

wherein C_{R} is the total amount of contributions received by the charity in a given tax period (e.g., current tax period), and X is the expenses of the charity in the given tax period. The expenses, X, can be calculated from the gross total operating expenses (E_{O}) minus the sum of the grants given to the government (E_{G}), grants given to individuals (E_{I}), and grants given to foreign governments (E_{F}). Values for C_{R}, E_{O}, E_{G}, E_{I}, and E_{F} can be obtained from the Finance CSV 628 provided by the second IRS database 626. Again, future tax forms may include different headings and definitions of the values relevant to the total amount of contributions received and the expenses of the charity. The FG Expense Number equation above is easily adjustable for such forms so long as it captures the objective information described above with respect to the quotient of total contributions received divided by non-charitable grant related expenses.

The Fastgiving Number can be used to compare the efficiency of charities. For example, a charity with a Fastgiving Number of 5 spent more on the sum of its total grants given to the government, the total grants given to individuals, and the total grants given to foreign governments than a charity with a Fastgiving Number of 100. In a further example, if a charity were to receive $1,000,000 in Contributions and spend $1,000,000 in that fiscal year on the sum of their total grants given to the government, the total grants given to individuals, and the total grants given to foreign governments the charity will have a Fastgiving Number of 1. If, however, a charity were to receive $1,000,000 in Contributions and spend $500,000 in that fiscal year on the sum of their total grants given to the government, the total grants given to individuals, and the total grants given to foreign governments the charity will have a Fastgiving Number of 2. The Fastgiving Number 1 indicates higher efficiency than the Fastgiving Number 2. The charity with the Fastgiving Number 1 spent twice as much of its Contributions on the sum of their total grants given to the government, the total grants given to individuals, and the total grants given to foreign governments compared to the charity with the Fastgiving Number of 2.

In some embodiments of the system, additional metrics generator(s) (not shown in figures) may be included to calculate different objective scores 636 reflecting other aspects of the charity's financial behavior. Any of the financial data contained in the Finance CSV 628 can be used to determine the other metrics. Examples of other metrics may include the ratio of contributions received per year to salaries (only) spent per year, or the ratio of contributions spent per year to advertising costs (only) spent per year. A number of additional metrics are described below. It is further noted that a single metrics generator may be used to generate both metrics 632 and 634 (as well as other metrics 636).

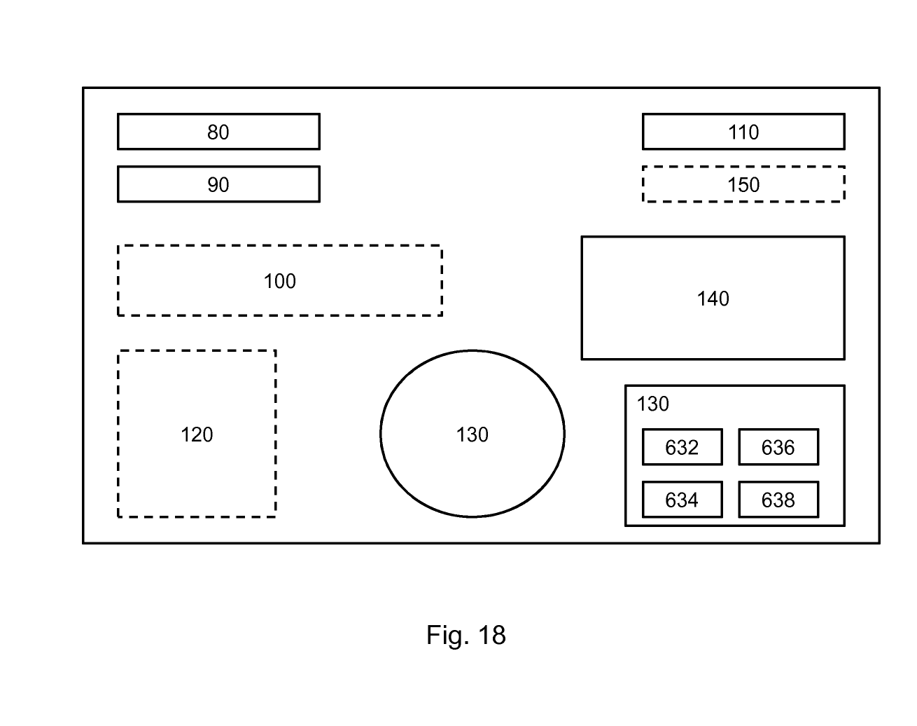

Once the metrics 632 and 634 have been generated, they are transmitted to the user terminal 640—which originally sent the search request 642—for display. In one embodiment, the metrics are displayed through a webpage of an internet site (e.g., Fastgive's website, www.fastgive.com) which a user has accessed. FIG. 18 (similar to FIG. 2) is a view of a webpage providing the name(s) 80 of the searched charity, its basic focus 90, mission 100, a code 110 for the charity (like a stock ticker symbol), and information about how the charity uses its donations/contributions 120. The webpage also includes a budget and accounting breakdown 130, wherein the metrics 632, 634, and 636 are shown. Additionally, the performance metrics server(s) 600 may be configured to provide a graph or chart 638 showing the historical trend of the charity's Fastgiving Number and/or the FG Expense Number. In other embodiments, such as those described below, the generated metrics 632 and 634 are stored in memory storage 608 for later retrieval on demand from terminal(s) 640. The stored metrics are associated with the unique public IDs in some embodiments as described herein. The webpage shown in FIG. 18, as well as other webpages associated with each charity on the website, will also include a field in which a user can input an amount that the user wishes to donate and a clickable button that will initiate a donation by the user to the charity via the website. In some embodiments, the webpage will include predesignated donation amounts shown as links so that users can simply donate by clicking on the predesignated amount link.

Embodiments of the present invention generate and utilize a variety of other metrics. These include:

$$Fastgiving Grants to Foreign Governments Number = \frac{CR}{EF} \qquad ( 3 )$$

wherein CR is the total amount of Contributions received by the charity in a given tax period (e.g., current tax period), and EF is the total amount spent by the charity towards Grants to Foreign Governments in the given tax period. The values for CR and EF can be obtained from the Finance CSV 628 originating from the second IRS database 626. Again future tax forms may include different headings and definitions of the values relevant to the total amount of Contributions received and Grants to Foreign Governments spent by the charity. The Fastgiving Grants to Foreign Governments Number equation above is easily adjustable for such forms so long as it captures the objective information described above with respect to the quotient of Contributions received divided by the Grants to Foreign Governments spent.

The Fastgiving Grants to Foreign Governments Number can be used to compare the efficiency of charities. For example, a charity with a Fastgiving Grants to Foreign Governments Number of 5 spent more on its Grants to Foreign Governments than a charity with a Fastgiving Grants to Foreign Governments Number of 100. In a further example, if a charity were to receive $1,000,000 in Contributions and spend $1,000,000 in that fiscal year on their Grants to Foreign Governments the charity will have a Fastgiving Grants to Foreign Governments Number of 1. If, however, a charity were to receive $1,000,000 in Contributions and spend $500,000 in that fiscal year on their Grants to Foreign Governments the charity will have a Fastgiving Grants to Foreign Governments Number of 2. The Fastgiving Grants to Foreign Governments Number 1 indicates higher efficiency than the Fastgiving Grants to Foreign Governments Number 2. The charity with the Fastgiving Grants to Foreign Governments Number 1 spent twice as much of its Contributions on Grants to Foreign Governments compared to the charity with the Fastgiving Grants to Foreign Governments Number of 2.

$$Fastgiving Grants to Individuals Number = \frac{CR}{EI} \qquad ( 4 )$$

wherein CR is the total amount of Contributions received by the charity in a given tax period (e.g., current tax period), and EI is the total amount spent by the charity towards Grants to Individuals in the given tax period. The Values for CR and EI, can be obtained from the Finance CSV 628 originating from the second IRS database 626. Future tax forms may include different headings and definitions of the values relevant to the total amount of Contributions received and Grants to Individuals spent by the charity. The Fastgiving Grants to Individuals Number equation above is easily adjustable for such forms so long as it captures the objective information described above with respect to the quotient of Contributions received divided by the Grants to Individuals spent.

The Fastgiving Grants to Individuals Number can be used to compare the efficiency of charities. For example, a charity with a Fastgiving Grants to Individuals Number of 5 spent more on its Grants to Individuals than a charity with a Fastgiving Grants to Individuals Number of 100. In a further example, if a charity were to receive $1,000,000 in Contributions and spend $1,000,000 in that fiscal year on their Grants to Individuals the charity will have a Fastgiving Grants to Individuals Number of 1. If, however, a charity were to receive $1,000,000 in Contributions and spend $500,000 in that fiscal year on their Grants to Individuals the charity will have a Fastgiving Grants to individuals Number of 2. The Fastgiving Grants to Individuals Number 1 indicates higher efficiency than the Fastgiving Grants to Individuals Number 2. The charity with the Fastgiving Grants to Individuals Number 1 spent twice as much of its Contributions on Grants to Individuals compared to the charity with the Fastgiving Grants to Individuals Number of 2.

$$Fastgiving Grants to the Governemnet Number = \frac{CR}{EG} \qquad ( 5 )$$

wherein CR is the total amount of contributions received by the charity in a given tax period (e.g., current tax period), and EG is the total amount spent by the charity towards Grants to the Government in the given tax period. The Values for CR and EG, can be obtained from the Finance CSV 628 originating from the second IRS database 626. Again future tax forms may include different headings and definitions of the values relevant to the total amount of Contributions received and Grants to the Government spent by the charity. The Fastgiving Grants to the Government Number equation above is easily adjustable for such forms so long as it captures the objective information described above with respect to the quotient of Contributions received divided by the Grants to the Government spent.

The Fastgiving Grants to the Government Number can be used to compare the efficiency of charities. For example, a charity with a Fastgiving Grants to the Government Number of 5 spent more on its Grants to the Government than a charity with a Fastgiving Grants to the Government Number of 100. In a further example, if a charity were to receive $1,000,000 in Contributions and spend $1,000,000 in that fiscal year on their Grants to the Government the charity will have a Fastgiving Grants to the Government Number of 1. If, however, a charity were to receive $1,000,000 in Contributions and spend $500,000 in that fiscal year on their Grants to the Government the charity will have a Fastgiving Grants to the Government Number of 2. The Fastgiving Grants to the Government Number 1 indicates higher efficiency than the Fastgiving Grants to the Government Number 2. The charity with the Fastgiving Grants to the Government Number 1 spent twice as much of its Contributions on Grants to the Government compared to the charity with the Fastgiving Grants to the Government Number of 2.

$$FG Advertising and Promotion Number = \frac{CR}{AP} \qquad ( 6 )$$

wherein CR is the total amount of contributions received by the charity in a given tax period (e.g., current tax period) and AP is Advertising and Promotion expenses in a given tax period. AP can be calculated from the sum of Advertising expenses and Promotion expenses spent by the charity in a given tax period which can, in some embodiments, be attained by the data of a single line item in the Finance CSV 628 provided by the second IRS database 626. The Values for CR and AP can be obtained from the Finance CSV 628 provided by the second IRS database 626. Again, future tax forms may include different headings and definitions of the values relevant to the total amount of contributions received and the Advertising and Promotion expenses of the charity. The FG Advertising and Promotion Number equation above is easily adjustable for such forms so long as it captures the objective information described above with respect to the quotient of total contributions received divided by Advertising and Promotion expenses.

The FG Advertising and Promotion Number can be used to compare the efficiency of charities. For example, a charity with an FG Advertising and Promotion Number of 5 spends more on its Advertising and Promotion than a charity with an FG Advertising and Promotion Number of 100. In a further example, if a charity were to receive $1,000,000 in contributions and spend $1,000,000 in that fiscal year on their Advertising and Promotion, the charity will have a FG Advertising and Promotion Number of 1. If, however, a charity were to receive $1,000,000 in Contributions and spend $500,000 in that fiscal year on their Advertising and Promotion the charity will have a FG Advertising and Promotion Number of 2. The FG Advertising and Promotion Number 2 indicates higher efficiency than the FG Advertising and Promotion Number 1. The charity with the FG Advertising and Promotion Number 2 spent half as much on its Advertising and Promotion compared to what it raised in contributions.

$$FG Compensation \& Wages Number = \frac{CR}{X} = \frac{CR}{( COD + SW )} \qquad ( 7 )$$

wherein CR is the total amount of contributions received by the charity in a given tax period (e.g., current tax period), and X is the compensation of current officers and directors (COD), and workers' salaries and wages (SW) in a given tax period. The compensation, wages, and salaries, X, can be calculated from the gross total Compensation of current Officers and Directors plus Other workers' Salaries and Wages. Values for CR, COD, and SW can be obtained from the Finance CSV 628 provided by the second IRS database 626. Again, future tax forms may include different headings and definitions of the values relevant to the total amount of contributions received and the compensation of current officers, directors, and workers' salaries and wages of the charity. The FG Compensation & Wages Number equation above is easily adjustable for such forms so long as it captures the objective information described above with respect to the quotient of total contributions received divided by the sum of Compensation of current Officers and Directors plus Other workers' Salaries and Wages.

The FG Compensation & Wages Number can be used to compare the efficiency of charities. For example, a charity with an FG Compensation & Wages Number of 5 spends more on its Compensation & Wages related expenses, comparatively, than a charity with an FG Compensation & Wages Number of 100. In a further example, if a charity were to receive $1,000,000 in contributions and spend $1,000,000 in that fiscal year on their Compensation & Wages expenses, the charity will have a FG Compensation & Wages Number of 1. If, however, a charity were to receive $1,000,000 in contributions and spend $500,000 in that fiscal year on their Compensation & Wages related expenses, the charity will have a FG Compensation & Wages Number of 2. The FG Compensation & Wages Number 2 indicates higher efficiency than the FG Compensation & Wages Number 1. The charity with the FG Compensation & Wages Number 2 spent half as much on its Compensation & Wages compared to what it raised in contributions.

$$FG Compensation Number = \frac{CR}{COD} \qquad ( 8 )$$

wherein CR is the total amount of contributions received by the charity in a given tax period (e.g., current tax period), and COD is the compensation of current officers and directors (COD) in a given tax period. The Values for CR and COD can be obtained from the Finance CSV 628 provided by the second IRS database 626. Again, future tax forms may include different headings and definitions of the values relevant to the total amount of contributions received and the compensation of current officers and directors of the charity. The FG Compensation Number equation above is easily adjustable for such forms so long as it captures the objective information described above with respect to the quotient of total contributions received divided by Compensation of current Officers and Directors.

The FG Compensation Number can be used to compare the efficiency of charities. For example, a charity with an FG Compensation Number of 5 spends more on its Compensation related expenses, comparatively, than a charity with an FG Compensation Number of 100. In a further example, if a charity were to receive $1,000,000 in contributions and spend $1,000,000 in that fiscal year on their Compensation expenses, the charity will have a FG Compensation Number of 1. If, however, a charity were to receive $1,000,000 in contributions and spend $500,000 in that fiscal year on their Compensation related expenses, the charity will have a FG Compensation Number of 2. The FG Compensation Number 2 indicates higher efficiency than the FG Compensation Number 1. The charity with the FG Compensation Number 2 spent half as much on its Compensation compared to what it raised in contributions.

$$FG Fundraising Number = \frac{FI}{X} = \frac{FI}{( FE + PFF )} \qquad ( 9 )$$

wherein FI is the Fundraising Income received by the charity in a given tax period (e.g., current tax period), and X is Gross Fundraising expense in a given tax period. X can be calculated from the sum of Fundraising expenses and Professional fundraising fees spent by the charity in a given tax period (e.g., current tax period), The Values for FI, FE, and PFF can be obtained from the Finance CSV 628 provided by the second IRS database 626. Again, future tax forms may include different headings and definitions of the values relevant to the Fundraising Income received, Fundraising expenses and the Professional fundraising fees spent by the charity. The FG Fundraising Number equation above is easily adjustable for such forms so long as it captures the objective information described above with respect to the quotient of Fundraising Income received divided by the sum of the Fundraising expenses and the Professional fundraising fees.

The FG Fundraising Number can be used to compare the efficiency of charities. For example, a charity with an FG Fundraising Number of 5 spends more on its Fundraising than a charity with an FG Fundraising Number of 100. In a further example, if a charity were to receive $1,000,000 in Fundraising Income and spend $1,000,000 in that fiscal year on their Fundraising expenses and Professional fundraising fees, the charity will have a FG Fundraising Number of 1. If, however, a charity were to receive $1,000,000 in Fundraising Income and spend $500,000 in that fiscal year on their Fundraising expenses and Professional fundraising fees, the charity will have a FG Fundraising Number of 2. The FG Fundraising Number 2 indicates higher efficiency than the FG Fundraising Number 1. The charity with the FG Fundraising Number 2 spent half as much on its Fundraising expenses and Professional fundraising fees compared to what it raised in Fundraising Income.

$$FG Fundraising v Contributions Number = \frac{CR}{X} = \frac{CR}{( FE + PFF )} \qquad ( 10 )$$

wherein CR is the total amount of contributions received by the charity in a given tax period (e.g., current tax period) and X is gross Fundraising expense in a given tax period. X can be calculated from the sum of Fundraising expenses (FE) and Professional fundraising fees (PFF) spent by the charity in a given tax period, The Values for CR, FE, and PFF can be obtained from the Finance CSV 628 provided by the second IRS database 626. Again, future tax forms may include different headings and definitions of the values relevant to the Contributions received, Fundraising expenses and the Professional fundraising fees spent by the charity. The FG Fundraising v Contributions Number equation above is easily adjustable for such forms so long as it captures the objective information described above with respect to the quotient of Contributions received divided by the sum of the Fundraising expenses and the Professional fundraising fees.

The FG Fundraising v Contributions Number can be used to compare the efficiency of charities. For example, a charity with an FG Fundraising v Contributions Number of 5 spends more on its Fundraising than a charity with an FG Fundraising v Contributions Number of 100. In a further example, if a charity were to receive $1,000,000 in Contributions and spend $1,000,000 in that fiscal year on their Fundraising expenses and Professional fundraising fees, the charity will have a FG Fundraising v Contributions Number of 1. If, however, a charity were to receive $1,000,000 in Contributions and spend $500,000 in that fiscal year on their Fundraising expanses and Professional fundraising fees, the charity will have a FG Fundraising v Contributions Number of 2. The FG Fundraising v Contributions Number 2 indicates higher efficiency than the FG Fundraising v Contributions Number 1. The charity with the FG Fundraising v Contributions Number 2 spent half as much on its Fundraising expenses and Professional fundraising fees compared to what it raised in Contributions.

$$FG Gaming Number = \frac{GI}{GE} \qquad ( 11 )$$

wherein GI is the Gaming Income received by the charity in a given tax period (e.g., current tax period), and GE is Gaming Expense in a given tax period. The Values for GI and GE can be obtained from the Finance CSV 628 provided by the second IRS database 626. Again, future tax forms may include different headings and definitions of the values relevant to the Gaming income received and Gaming expenses spent by the charity. The FG Gaming Number equation above is easily adjustable for such forms so long as it captures the objective information described above with respect to the quotient of Gaming Income received divided by the Gaming expense.

The FG Gaming Number can be used to compare the efficiency of charities. For example, a charity with an FG Gaming Number of 5 spends more on its Gaming than a charity with an FG Gaming Number of 100. In a further example, if a charity were to receive $1,000,000 in Gaming Income and spend $1,000,000 in that fiscal year on their Gaming expenses the charity will have a FG Gaming Number of 1. If, however, a charity were to receive $1,000,000 in Gaming Income and spend $500,000 in that fiscal year on their Gaming expenses the charity will have a FG Gaming Number of 2. The FG Gaming Number 2 indicates higher efficiency than the FG Gaming Number 1. The charity with the FG Gaming Number 2 spent half as much on its Gaming expenses compared to what it raised in Gaming Income.

$$FG Gaming v Contributions Number = \frac{CR}{GE} \qquad ( 12 )$$

wherein CR is the total amount of contributions received by the charity in a given tax period (e.g., current tax period) and GE is Gaming expenses in a given tax period. The Values for CR and GE can be obtained from the Finance CSV 628 provided by the second IRS database 626. Again, future tax forms may include different headings and definitions of the values relevant to the total amount of Contributions received and Gaming expenses spent by the charity. The FG Gaming v Contributions Number equation above is easily adjustable for such forms so long as it captures the objective information described above with respect to the quotient of Contributions received divided by the Gaming expenses.

The FG Gaming v Contributions Number can be used to compare the efficiency of charities. For example, a charity with an FG Gaming v Contributions Number of 5 spends more on its Gaming than a charity with an FG Gaming v Contributions Number of 100. In a further example, if a charity were to receive $1,000,000 in Contributions and spend $1,000,000 in that fiscal year on their Gaming expenses the charity will have a FG Gaming v Contributions Number of 1. If, however, a charity were to receive $1,000,000 in Contributions and spend $500,000 in that fiscal year on their Gaming expenses the charity will have a FG Gaming v Contribution Number of 2. The FG Gaming v Contribution Number 2 indicates higher efficiency than the FG Gaming v Contribution Number 1. The charity with the FG Gaming v Contribution Number 2 spent half as much on its Gaming expenses compared to what it raised in Contributions.

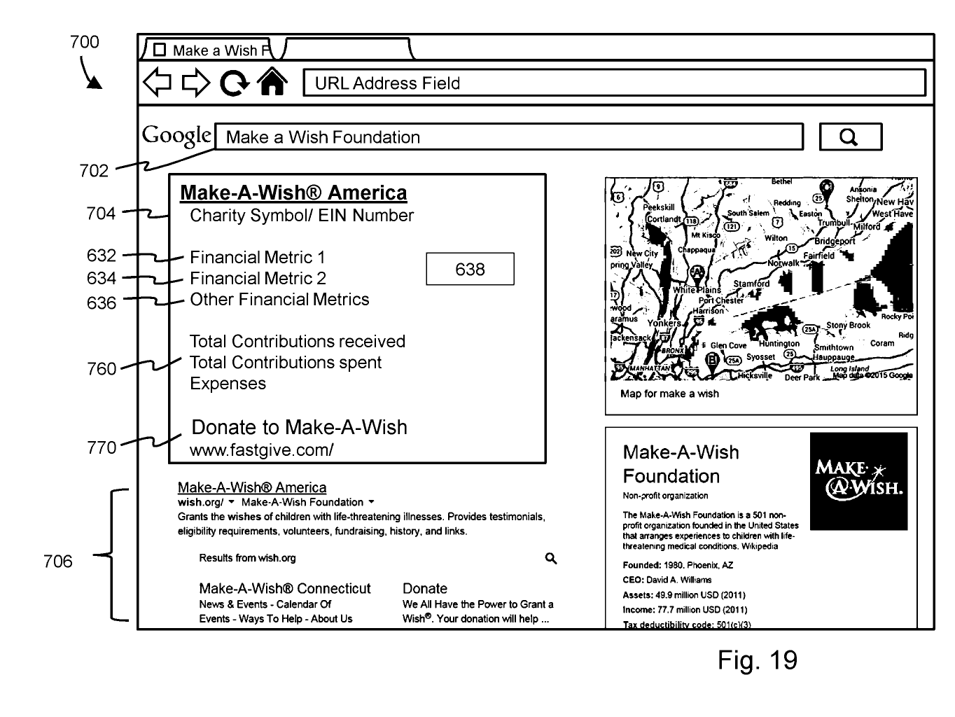

In another embodiment, the metrics are displayed within a search engine (e.g., Google®, Bing®, Yahoo!®), when a search for a particular charity is performed. For example, FIG. 19 shows a search engine 700, wherein a search for the “Make A Wish Foundation” charity is made in the search field 702. The search engine then displays a financial synopsis 704 above the typical search result list 706. Note, the financial synopsis 704 may instead be displayed on the right-hand side adjacent to the search result list 706. The financial synopsis 704 includes the charity's code and/or EIN number, metrics 632 (Fastgiving Number), metrics 634 (FG Expense Number), other metrics 636, as well as other financial data 760 originating directly from the Finance CSV 628. Moreover, the financial synopsis may include a direct link 770 to the internet site of FIGS. 1-10, where a user can make a donation to the charity.

The memory storage unit 608 may be configured to save the objective scores/metrics 632, 634, 636 for later use. For example, in order to create the historical trend graph or chart 638, the performance metrics server(s) 600 accesses the memory storage unit 608 to retrieve metrics from past tax periods.

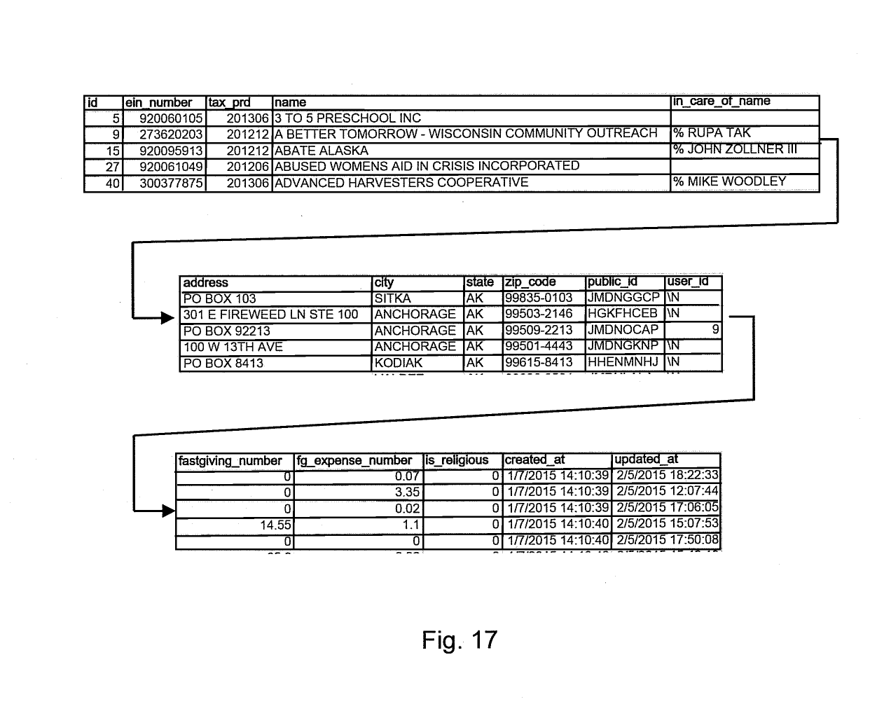

In some embodiments of the system, the performance metrics server(s) 600 also creates a unique public ID code—separate from the charity's EIN number—to identify the charity from other charities. This public ID code is the same as the code 110 discussed above with respect to FIG. 2. The performance metrics server(s) 600 is also configured to determine whether the charity is a religious organization or is affiliated with a religious organization. This religious determination may be accomplished through analysis of the charity's EIN Master CSV and Finance CSV and/or through an automated search of the charity's website for “religious” keywords. In other embodiments, religious organizations are signed up by simply attesting that they are such an organization. In other embodiments, a religious organization can be checked against a published list of such organizations. The public ID code and the religious determination (0 denotes non-religious, 1 denotes religious) may be saved along with the charity's Fastgiving Number (metric 632), FG Expense Number (metric 634), and other metrics 636 by the memory storage unit 608 (shown in, for example, FIG. 13) in an output file shown in FIG. 17. FIG. 17, in particular, shows information for several charities collected into a single output file. However, the system may be configured such that a separate output file is created for each charity. Moreover, the performance metrics server(s) 600 records timestamps that indicate when (date and time) the data entries in the output file were originally created (i.e., “Created At” column) and when the data entries are updated (i.e., “Updated At” column). The “Updated At” field helps to indicate the last time the performance metrics were calculated, especially since charities do not necessarily file tax returns according to calendar year, but according to a fiscal year. In some embodiments, the system transmits the output file to the user terminal(s) 640 for downloading.

The system for generating objective performance metrics for charities described above provides for an on-demand determination of metrics 632, 634 (and metrics 636). That is, the metrics are not calculated and updated until a search request 642 is received by the performance metrics server(s) 600. Alternatively, or in addition thereto, the system may be configured so that the process of generating metrics is performed automatically on a periodic basis (e.g., hourly, daily, weekly, biweekly, monthly, quarterly, bi-annually, annually) for all charities, regardless if there is a search request. For example, every 1st of the month, the network interface 606 establishes a connection with the IRS databases 622, 626 to retrieve the EIN Master CSV 624 and Finance CSV 628 for all charities, and the metrics generators 602, 604 iteratively calculates the metrics 632 and 634 for each charity. The generated metrics are then saved in the output file of FIG. 17 (also adjusting the “Updated At” field) for later use. This configuration of the system is advantageous because it enables the system to provide the objective metrics much quicker, because upon receiving a search request 642 for a particular charity, the system can access the local memory of the storage unit 608 to obtain and transmit the metrics 632, 634 to the terminal 640 making the request, without initiating the metrics generators 602, 604. Additionally, the periodic processing of metrics is beneficial if the network interface control unit 606 encounters a connection error. For example, upon receiving a search request 642, if the network interface control unit 606 is unable to establish a connection to the IRS databases 622, 626 (or IRS database 650), then the system merely accesses the memory storage unit 608 to get the objective metrics. As a result, the system has a form of redundancy such that it can still function when communication with the IRS databases fails.

In some embodiments of the system, there is a verification unit which is either separate or part of the performance metrics server(s) 600. The verification unit is configured to provide independent verification of the generated metrics 632, 634, and other metrics 636 if available. If a charity believes that the generated metrics are incorrect or inaccurate, the organization can send a verification request from the one or more user terminal(s) 640. Upon receiving the verification request, the verification unit sends a query to the user terminal(s) asking whether the verification should be conducted by the charity's personal accounting firm or by a third-party accounting firm and further asking for the name and contact information of the personal accounting firm or third-party accounting firm (which the charity wishes to hire). After a selection regarding the accounting firm is made, the verification unit contacts the accounting firm via electronic communication (e.g., transmission signal to the firm's servers, email, text message, etc.) requesting that it obtain the necessary data from the personal accounting firm or third party to calculate the metrics 632, 634 and other metrics 636. The verification unit is configured to receive the verified metrics values from the personal accounting firm or third-party accounting firm via electronic communication. The metrics generators 602 and 604 are subsequently updated and the updated data/information is then processed and sent to memory 608 with the verified metrics and saves the verified metrics in the output file shown in FIG. 17, which is resident in memory 608. In some embodiments, the verification unit may include a validator which compares the “alleged incorrect” metrics with the verified metrics and performs a discrepancy analysis to determine where mismatches are present.

The system of FIGS. 11-13 may also be configured to create and host the website/webpages of FIGS. 1-10 and effect charitable contributions over a network (e.g., Internet). The system includes a web host unit or module 610 to perform all necessary hosting functions. The web host unit may be an independent unit connected to the performance metrics server(s) 600 or part of the performance metrics server(s) 600. The web host unit includes a patron registration component to register a patron(s) on the website, a charity registration component to register a plurality of charities on the website, and a charity page design unit to build a charity page on the website for each of the charities using information obtained about the charity. The web host unit is adapted to facilitate the display of the charity pages to one or more patrons visiting the website. The web host unit may also assist in transmitting the performance metrics and public identification code (110 in FIG. 2) for display in a webpage. An accounts component may be provided with the web host unit to receive a selection from the patron of at least one of the charities for adding the selected charity to a portfolio of the patron. Further, a payment component may be provided with the web host unit to receive a specification of an amount of at least one contribution to at least one of the charities in the patron's portfolio and to remit the at least one contribution to the at least one of the charities upon receipt of the specification.

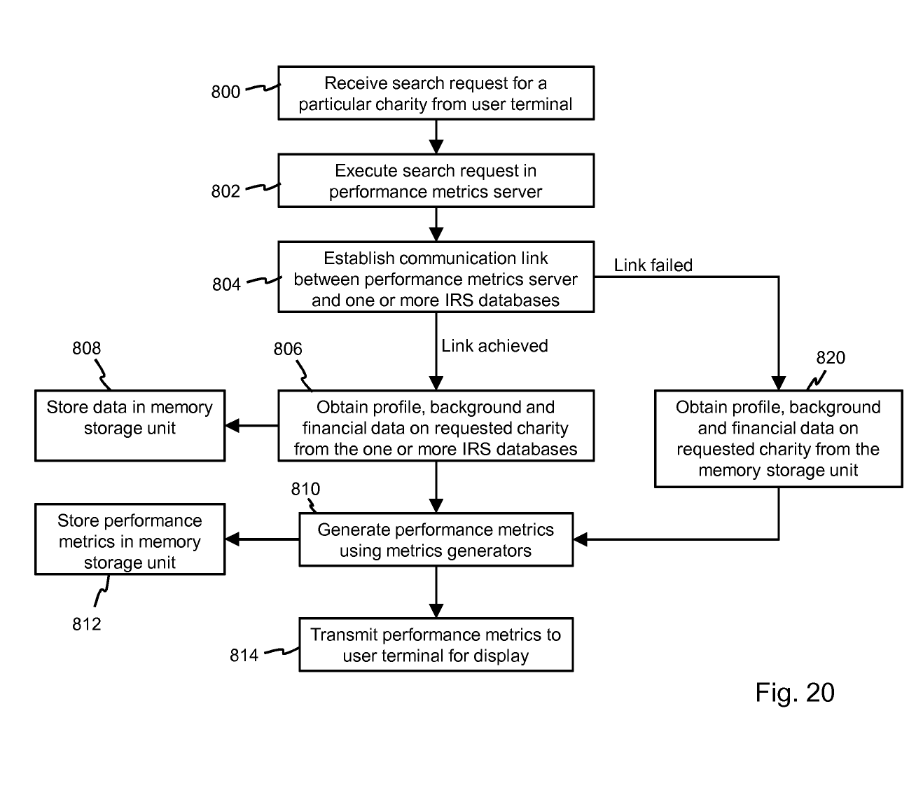

Referring to FIG. 20, there is shown a flowchart of one embodiment of a method according to the present teachings. The method comprises the following steps of: receiving a search request for a particular charity from a user terminal (step 800); executing the search request in a performance metrics server (step 802); establishing a communications link between the performance metrics server and one or more IRS databases (step 804); obtaining profile, background and financial data—e.g., EIN Master CSV and Finance CSV—on the requested charity from the one or more IRS databases (step 806); generating objective performance metrics using metrics generators (step 810); and transmitting the performance metrics to the user terminal for display (step 814). The method may further comprise saving the profile, background and financial data—e.g., EIN Master CSV and Finance CSV—in a local memory storage unit (step 808) after retrieval from the IRS databases. Similarly, the method may comprise saving the generated performance metrics in the local memory storage unit (step 812).

FIG. 20 also shows the detail steps when the network interface control unit fails to establish a communications link with the one or more IRS databases. Specifically, when a connection error is encountered, the method involves obtaining the profile, background and financial data on the requested charity from the local memory storage unit (step 820), instead of proceeding with step 806. Thereafter, the method continues with step 810 and finishes with step 814.

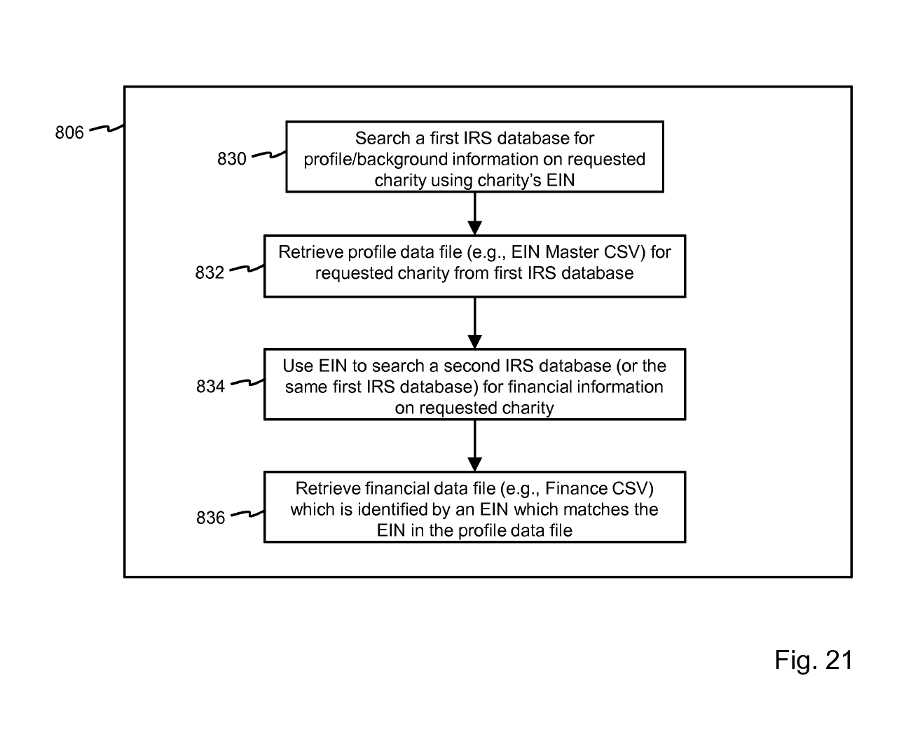

FIG. 21 shows additional steps involved in obtaining profile, background and financial data—e.g., EIN Master CSV and Finance CSV—on the requested charity from the one or more IRS databases (step 806). Specifically, step 806 further comprises the steps of: searching a first IRS database for profile/background information on the requested charity using the charity's EIN (step 830); retrieving a profile data file (e.g., EIN Master CSV) associated with the requested charity from the first IRS database (step 832); using the EIN to search a second IRS database (or the same first IRS database if there is only one IRS database) for financial information on the charity (step 834); and retrieving a financial data file (e.g., Finance CSV) which has an EIN that matches the EIN in the profile data file. In some embodiments, all of the data in the IRS databases is pulled for use by the system. In other embodiments, only the data needed to calculate the metrics and to associate them with a charity is pulled. Additional steps in some embodiments include generating a unique “Public ID” to associate with the charity.

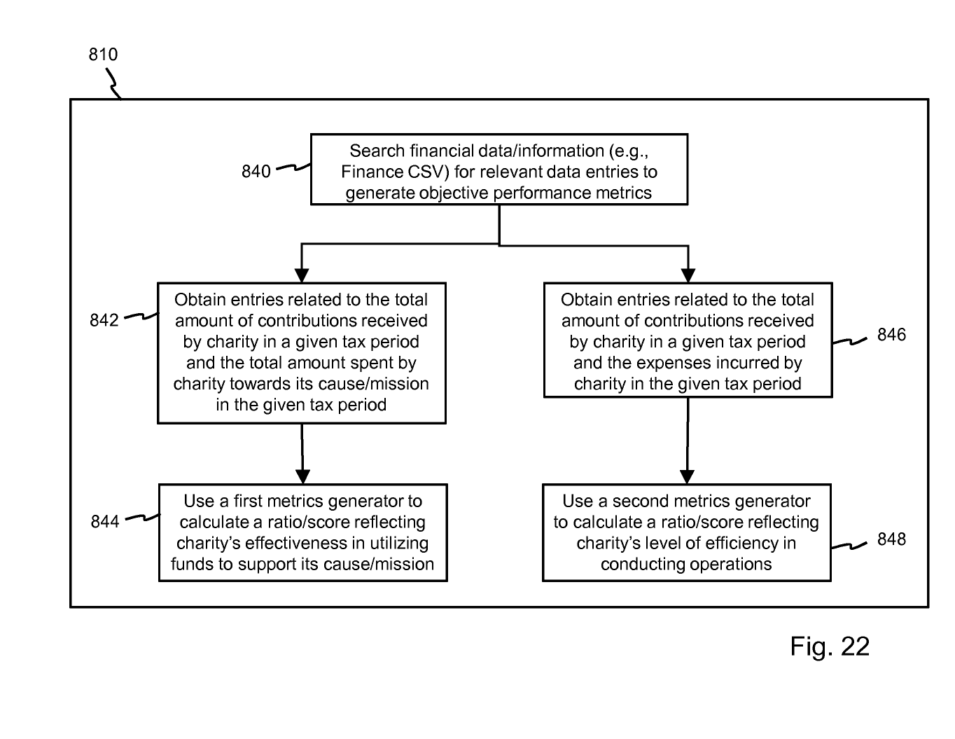

FIG. 22 shows additional steps involved in generating objective performance metrics using metrics generators (step 810). Step 810 includes further steps of: searching the financial data of the charity (e.g., Finance CSV) for relevant data entries to generate objective performance metrics on the charity's fiscal behavior and financial effectiveness (step 840); obtaining entries (i.e., values) related to the total amount of contributions received by the charity in a given tax period and the total amount spent by the charity towards its cause/mission in the given tax period (step 842); and using a first metrics generator to calculate a ratio/score reflecting the charity's effectiveness in utilizing funds to support its cause/mission, also known as the Fastgiving Number (step 844). There is also the steps of: obtaining entries (i.e., values) related to the total amount of contributions received by the charity in the given tax period (step 846); and using a second metrics generator to calculate a ratio/score reflecting the charity's level of efficiency in conducting operations, also known as the FG Expense Number (step 848). In some embodiments, steps 842, 844 are performed at the same time or substantially the same time steps 846, 848 are performed. In other embodiments, steps 842, 844 are performed in sequence either before or after steps 846, 848.

Accordingly, the present invention provides a method, system, and means for creating a competitive marketplace for charities and patrons in an online social networking environment. The present invention also provides a system, method and means for generating objective performance metrics reflecting the fiscal behavior and financial effectiveness of a charity and allowing for the utilization of the metrics of two or more charities to compare charities using the objective metrics produced by the process.

Those skilled in the art will recognize, upon consideration of the above teachings, that the above embodiments are based upon the use of one or more hardware components and/or software components executing on computer readable medium(s). Further, computers, microprocessor based computers, desktops, laptops, tablets, smartphones, application specific circuits and/or hardwired logic may be used to construct alternative equivalent embodiments.

The present invention has been described above in terms of a presently preferred embodiment so that an understanding of the present invention can be conveyed. However, many alternative ways of constructing the system, website, software engine, and internet systems are possible without departing from the principle of the invention and will come to mind to those skilled in the art to which this pertains. The scope of the present invention should therefore not be limited by the embodiments illustrated, but rather it should be understood that the present invention has wide applicability with respect to its stated objectives. All modifications, variations, or equivalent elements and implementations should therefore be considered within the scope of the invention.

What is claimed is:

1. A system for generating metrics reflecting a charity's fiscal behavior and financial effectiveness, comprising:
at least one metrics server in communication with at least one terminal, the metrics server for receiving a search request from one of the at least one terminal, the search request being a signal requesting a search on a charity;
the at least one metrics server for retrieving profile information on the charity from a first database over a network and for retrieving financial information on the charity from a second database over the network;
at least one metrics generator for analyzing the financial information to obtain data on a total amount of contributions received by the charity in a given tax period and data on a total amount of contributions spent by the charity in advancing a cause of the charity in the given tax period, the at least one metrics generator using the data on the total contributions received amount and the total contributions spent amount to generate at least one first score which indicates how effective the charity is in dispersing funds for goods and/or services related to the cause of the charity; and
a network interface controller transmitting the at least one first score to the one of the at least one terminal for display.

2. The system of claim 1, wherein the first score indicating how effective the charity is in dispersing funds for goods and/or services related to the cause of the charity is determined as a ratio of the total contributions received amount to the total contributions spent amount.

3. The system of claim 2, wherein the total contributions spent amount is calculated from a sum of grants and/or endowments given to a domestic government, grants and/or endowments given to individuals, and grants and/or endowments given to foreign governments.

4. The system of claim 1, wherein the at least one metrics generator comprises a first metrics generator and a second metrics generator;
the first metrics generator generating the first score indicating how effective the charity is in dispersing funds for goods and/or services related to the cause of the charity;
the second metrics generator for analyzing the financial information retrieved from the second database to obtain data on the total amount of contributions received by the charity in the given tax period and data on expenses of the charity in the given tax period, the second metrics generator using the data on the total contributions received amount and the expenses to generate a second score indicating how effectively the charity operates;
the network interface controller transmitting the first score generated by the first metrics generator and the second score generated by the second metrics generator to the one of the at least one terminal for display.

5. The system of claim 4, wherein the second score indicating how effectively the charity operates is determined as a ratio of the total contributions received amount to the expenses of the charity and wherein the expenses of the charity is calculated from gross total operating expenses of the charity in the given tax period minus a sum of grants and/or endowments given to a domestic government, grants and/or endowments given to individuals, and grants and/or endowments given to foreign governments.

6. The system of claim 1, wherein the network interface controller establishes communication links to the first and second databases upon the at least one metrics server receiving the search request, and further monitors a status of the communications links.

7. The system of claim 6, wherein:
the at least one metrics server searches through the first database using an identification code associated with the charity to obtain the profile information on the charity, the identification code having been assigned to the charity by a tax agency; and
the at least one metrics server using the identification code to search through the second database to retrieve the financial information which has a matching identification code.

8. The system of claim 1, further comprising a memory storage unit for saving the at least one first score generated by the at least one metrics generator and for saving at least one of the profile information from the first database or the financial information from the second database.

9. The system of claim 1, wherein the at least one metrics server transmits the at least one first score for display within a website providing at least one of an online marketplace or social network environment for charities and patrons.

10. The system of claim 1, wherein the at least one metrics server transmits the at least one first score for display in a search result list created by a search engine in response to a search for the charity being initiated in the search engine.

11. The system of claim 1, wherein the system generates an identification code for identifying the charity and associates the identification code to the at least one first score.

12. A system for generating metrics reflecting a charity's fiscal behavior and financial effectiveness, comprising:
at least one metrics server in communication with at least one terminal, the metrics server for receiving a search request from one of the at least one terminal, the search request being a signal requesting a search on a first charity;
a network interface controller configured to establish communication links between the at least one metrics server and a first database and a second database over a network in response to the search request;
the at least one metrics server for retrieving profile information on the first charity from the first database and for retrieving financial information on the first charity from the second database;
at least one metrics generator for analyzing the financial information retrieved from the second database to obtain data on a total amount of contributions received by the first charity in a given tax period and data on a total amount of contributions spent by the first charity in advancing a cause of the first charity in the given tax period, the at least one metrics generator using the data on the total contributions received amount and the total contributions spent amount to generate at least one first score which indicates how effective the first charity is in dispersing funds for goods and/or services related to the cause of the first charity; and
a web host unit which hosts a website providing an online marketplace for charities and patrons, the website comprising a charity webpage for each of the charities, wherein the web host unit is configured to transmit the charity webpage for the first charity with the at least one objective score for display on the one of the at least one terminal in response to the search request.

13. The system of claim 12, wherein the at least one metrics generator comprises a first metrics generator and a second metrics generator;
the first metrics generator for generating the first score indicating how effective the first charity is in dispersing funds for goods and/or services related to the cause of the first charity;
the second metrics generator for analyzing the financial information retrieved from the second database to obtain data on the total amount of contributions received by the first charity in the given tax period and data on expenses of the first charity in the given tax period, the second metrics generator using the data on the total contributions received amount and the expenses to generate a second score indicating how effective the first charity operates;
the web host unit transmitting the charity webpage for the first charity with the first and second scores for display on the one of the at least one terminal.

14. The system of claim 12, wherein the system generates an identification code for identifying the first charity and associates the identification code to the at least one first score.

15. A method for generating metrics reflecting a charity's fiscal behavior and financial effectiveness, comprising the steps of:
initiating a network interface controller to establish communication connections between at least one metrics server and a first database and a second database;
retrieving profile information on a charity from the first database and financial information on the charity from the second database;
analyzing the financial information on the metrics server to obtain data on a total amount of contributions received by the charity in a given tax period and data on a total amount of contributions spent by the charity in advancing a cause of the charity in the given tax period;
generating a first score using the data on the total contributions received amount and the total contributions spent amount, the first score indicating how effective the charity is in dispersing funds for goods and/or services related to the cause of the charity; and
transmitting the first score from the metrics server to at least one terminal for display.

16. The method of claim 15, wherein the first score indicating how effective the charity is in dispersing funds for goods and/or services related to the cause of the charity is determined as a ratio of the total contributions received amount to the total contributions spent amount, which is calculated from a sum of grants and/or endowments given to a domestic government, grants and/or endowments given to individuals, and grants and/or endowments given to foreign governments.

17. The method of 16, further comprising the steps of:
analyzing the financial information on the metrics server to obtain data on the total amount of contributions received by the charity in the given tax period and data on expenses of the charity in the given tax period;
generating a second score using the data on the total contributions received amount and expenses, the second objective score indicating how effective the charity operates;
wherein the second score is determined as a ratio of the total contributions received amount to the expenses of the charity; and
wherein the expenses of the charity is calculated from gross total operating expenses of the charity in the given tax period minus a sum of grants and/or endowments given to a domestic government, grants and/or endowments given to individuals, and grants and/or endowments given to foreign governments; and
transmitting the second objective score from the metrics server to the at least one terminal for display.

18. The method of claim 17, wherein the steps of retrieving the profile information and the financial information further comprises:
searching through the first database using an identification code associated with the charity to obtain the profile information on the charity, the identification code having been assigned to the charity by a tax agency; and
searching through the second database using the identification code to retrieve the financial information which has a matching identification code.

19. The method of claim 17, further comprising the steps of saving, in a memory storage unit, the objective score indicating how effective the charity is in dispersing funds for goods and/or services related to the cause of the charity and of saving in the memory storage unit, the profile information from the first database and the financial information from the second database.

20. The method of claim 17, wherein the transmitting step includes transmitting the objective score for display within a website providing an online marketplace for charities and patrons.

21. The method of claim 17, wherein the transmitting step includes transmitting the objective score for display in a search result list created by a search engine in response to a search for the charity being initiated in the search engine.
